(19) United States
(12) Patent Application Publication
(10) Pub. No.: US 2014/0146730 A1
(43) Pub. Date: May 29, 2014

(54) WIRELESS TERMINAL, COMMUNICATION CONTROL METHOD AND COMMUNICATION SYSTEM

(71) Applicant: Fujitsu Mobile Communications Limited, Kawasaki-shi (JP)

(72) Inventor: Naritoshi SAITO, Hino (JP)

(73) Assignee: Fujitsu Mobile Communications Limited, Kawasaki-shi (JP)

(21) Appl. No.: 14/088,075

(22) Filed: Nov. 22, 2013

(30) Foreign Application Priority Data
Nov. 27, 2012 (JP) 2012-258962

(51) Int. Cl. H04W 52/02

(52) U.S. Cl. CPC H04W 52/0251
USPC 370/311

(57) ABSTRACT

A disclosed wireless terminal includes a determination unit that determines whether or not the wireless terminal is outside of a communication area that is connectable with a first telecommunication network by radio; and a search unit that omits search for a base station or access point that relays communication with the first telecommunication network, upon determining that the wireless terminal is outside of the communication area. The aforementioned determination unit may further identify that the wireless terminal is inside of the communication area, and the search unit may further search for the base station or access point upon identifying that the wireless terminal is inside of the communication area.

### CROSS-REFERENCE TO RELATED APPLICATIONS

This application is based upon and claims the benefit of priority of the prior Japanese Patent Application No. 2012-258962, filed on Nov. 27, 2012, the entire contents of which are incorporated herein by reference.

### FIELD

This technique relates to a power saving technique of a wireless terminal that conducts wireless communication with a telecommunication network.

### BACKGROUND

A wireless terminal that will perform voice communication or data communication through a telecommunication network connects with a base station or access point that relays communication to the telecommunication network by radio.

In order to prepare the beginning of the communication, the wireless terminal repeats an operation to search for the base station or access point that is connectable, even in a state where there is no connection. The operation to search for the base station or access point consumes the power in the power supply in the wireless terminal, steadily.

In order to enhance the usability of the wireless terminal that conducts the voice communication or data communication, it is preferable that the power supply from the battery continues as long as possible. However, as described above, the operation conducted by the wireless terminal to search for the base station or access point is a factor that causes to shorten the period of the power supply from the battery in the wireless terminal.

### SUMMARY

A wireless terminal relating to a first aspect of the technique includes: a memory; and a processor configured to use the memory and execute a process including: determining whether or not the wireless terminal is outside of a communication area that is connectable with a first telecommunication network by radio; and upon determining that the wireless terminal is outside of the communication area, omitting search for a base station or access point that relays communication with the first telecommunication network.

A communication control method relating to a second aspect of the technique includes: (A) transmitting first information that represents a position of a wireless terminal from the wireless terminal to a communication system that controls a first telecommunication network that is connectable with the wireless terminal by radio; (B) receiving, by the communication system, the first information; (C) identifying, by the communication system, second information that represents a relationship between the wireless terminal and a communication area that is connectable to a second telecommunication network by radio, based on the position of the wireless terminal, which is represented by the received first information; (D) transmitting, by the communication system, the second information to the wireless terminal; (E) receiving, by the wireless terminal, the second information; and (F) determining, by the wireless terminal, whether or not the wireless terminal is outside of the communication area, based on the received second information. And search, by the wireless terminal, for abase station or an access point that relays the second telecommunication network is omitted upon determining that the wireless terminal is outside of the communication area.

A communication system relating to a third aspect of the technique is a communication system for controlling communication of a first telecommunication network that is connectable with a wireless terminal by radio. Then, the communication system includes: a memory; and one or plural processors configured to use the memory and execute a process including: (a) receiving first information that represents a position of the wireless terminal and is transmitted by the wireless terminal; (b) identifying second information that represents a relationship between the wireless terminal and a communication area that is connectable with a second telecommunication network by radio, based on the position of the wireless terminal, which is represented by the received first information; and (c) sending the identified second information to the wireless terminal.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram depicting an example of a communication environment of a multi-mode wireless terminal;

FIG. 2 is a diagram depicting an example of a hardware configuration of the multi-mode wireless terminal;

FIG. 3 is a diagram depicting a configuration example of transmission modems;

FIG. 4 is a diagram depicting a configuration example of receiving modems;

FIG. 5 is a schematic diagram of communication areas;

FIG. 6 is a diagram depicting a configuration example of a first voice communication system;

FIG. 7 is a diagram depicting an example of a message flow;

FIG. 8 is a diagram depicting a configuration example of functional modules of the multi-mode wireless terminal relating to transmission of a position message;

FIG. 9 is a diagram depicting an example of a processing flow of the multi-mode wireless terminal;

FIG. 10 is a diagram depicting an example of the position message;

FIG. 11 is a diagram depicting a configuration example of functional modules of the first voice communication system;

FIG. 12 is a diagram depicting an example of a processing flow relating to receipt of the position message in a message center;

FIG. 13 is a diagram depicting an example of a processing flow relating to transmission of an area message in a wireless information center;

FIG. 14 is a diagram depicting an example of a database;

FIG. 15 is a diagram depicting an example of area parameters;

FIG. 16 is a diagram depicting an example of the area message;

FIG. 17 is a diagram depicting an example of a processing flow relating to transmission of the area message in a message center;

FIG. 18 is a diagram depicting a configuration example of functional modules of the multi-mode wireless terminal, which relate to search for a base station or access point;

FIG. 19 is a diagram depicting an example of a processing flow relating to the search for the base station or access point in the multi-mode wireless terminal;

FIG. 20 is a diagram depicting an example of a processing flow relating to the search for the base station or access point for each communication method;

FIG. 21 is a diagram depicting an example of a database relating to a second embodiment;

FIG. 22 is a diagram depicting an example of the area parameter relating to the second embodiment;

FIG. 23 is a diagram depicting an example of communication areas;

FIG. 24 is a diagram depicting an example of the area message relating to the second embodiment;

FIG. 25 is a diagram depicting an example of a processing flow relating to the search for the base station or access point for each communication method in the second embodiment;

FIG. 26 is a diagram depicting an example of a processing flow relating to the search for the base station or access point for each communication method in the second embodiment;

FIG. 27 is a diagram depicting an example of a processing flow relating to the search for the base station or access point for each communication method in the second embodiment;

FIG. 28 is a diagram depicting an example of a processing flow relating to the search for the base station or access point for each communication method in the second embodiment;

FIG. 29 is a diagram depicting an example of a processing flow relating to the search for the base station or access point for each communication method in the second embodiment;

FIG. 30 is a diagram depicting an example of a message flow relating to a third embodiment;

FIG. 31 is a diagram depicting a configuration example of functional modules of the multi-mode wireless terminal, which relate to the third embodiment;

FIG. 32 is a diagram depicting an example of a processing flow of the multi-mode wireless terminal in the third embodiment;

FIG. 33 is a diagram depicting an example of the area message in the third embodiment;

FIG. 34 is a diagram depicting an example of the area message in the third embodiment;

FIG. 35 is a diagram depicting an example of a threshold parameter;

FIG. 36 is a diagram depicting an example of a result message;

FIG. 37 is a diagram depicting a configuration example of the first voice communication system in the third embodiment;

FIG. 38 is a diagram depicting a processing flow relating to receipt of the result message in the message center;

FIG. 39 is a diagram depicting an example of a processing flow relating to update of the database in the wireless information center; and

FIG. 40 is a diagram depicting a configuration example of a computer.

### DESCRIPTION OF EMBODIMENTS

### Embodiment 1

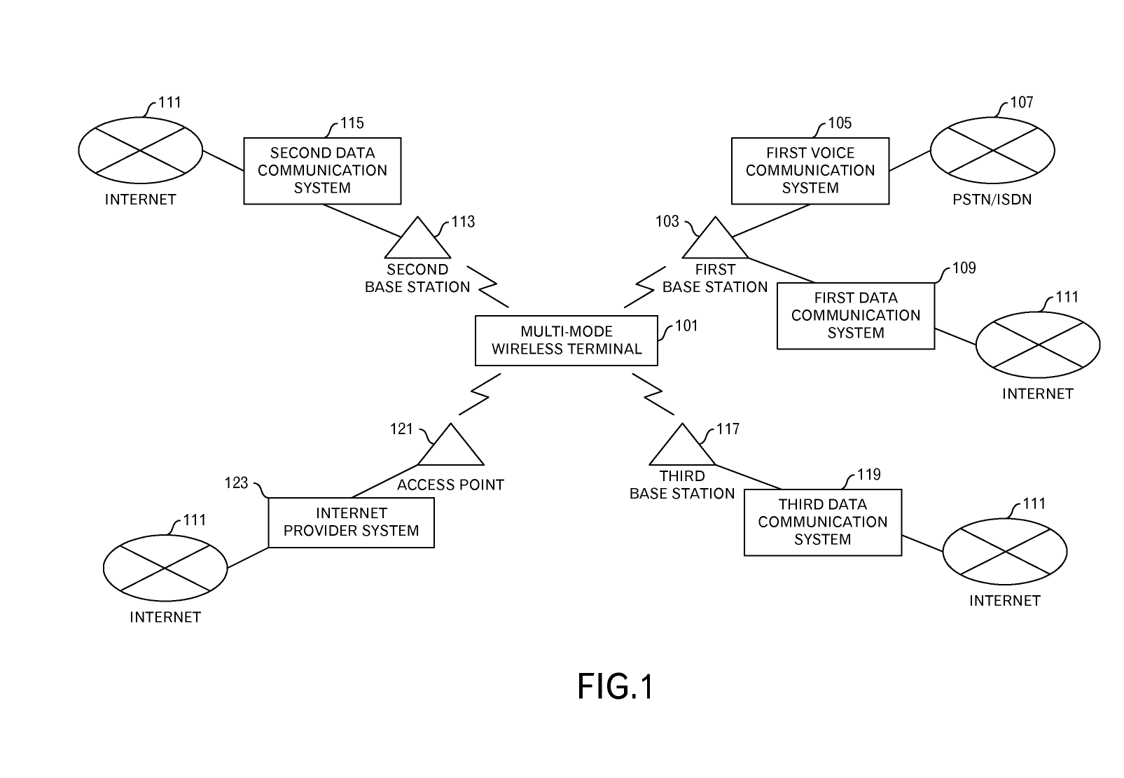

FIG. 1 illustrates an example of a communication environment for a multi-mode wireless terminal. The multi-mode wireless terminal 101 is a wireless terminal that is connectable to plural telecommunication networks whose communication method is different. Moreover, the multi-mode wireless terminal 101 may be carried, for example, by a user and may move.

The multi-mode wireless terminal 101 connects with a first base station 103 by radio in a first communication method, and performs the voice communication through a first voice communication system 105. FIG. 1 illustrates one first base station 103, however, plural first base stations 103 are connected to the first voice communication system 105, actually. The first voice communication system 105 is connected with Public Switched Telephone Networks (PSTN) or Integrated Services Digital Network (ISDN) 107. The first base station 103 and the first voice communication system 105 are portions of a configuration for the telecommunication network for the voice communication in the first communication method.

Moreover, the multi-mode wireless terminal 101 similarly connects with the first base station 103 by radio in the first communication method, and also performs the data communication through a first data communication system 109. In the data communication, a packet transfer is carried out, for example. FIG. 1 illustrates one first base station 103, however, plural first base stations 103 are connected with the first data communication system 109. The first data communication system 109 is connected with the internet 111. The multi-mode wireless terminal 101 transmits or receives internet mail by using the data communication, and further accesses Web sites. The first base station 103 and the first data communication system 109 are portions of a configuration of the telecommunication network for the data communication in the first communication method.

Moreover, the multi-mode wireless terminal 101 connects with a second base station 113 by radio in a second communication method, and performs the data communication through a second data communication system 115. FIG. 1 illustrates one second base station 113, however, plural second base stations 113 are connected with the second data communication system 115, actually. The second data communication system 115 is connected with the internet 111. The multi-mode wireless terminal 101 similarly receives or transmits internet mail by the data communication, and further accesses Web sites. The second base station 113 and the second data communication system 115 are portions of a configuration of the telecommunication network for the data communication in the second communication method.

Moreover, the multi-mode wireless terminal 101 connects with a third base station 117 by wireless in a third communication method, and also performs the data communication through a third data communication system 119. FIG. 1 illustrates one third base station 117, however, plural third base stations 117 are connected with the third data communication system 119, actually. The third data communication system 119 is connected with the internet 111. The multi-mode wireless terminal 101 similarly transmits or receives internet mail by the data communication, and further accesses Web sites. The third base station 117 and the third data communication system 119 are portions of a configuration of the telecommunication network for the data communication in the third communication method.

Moreover, the multi-mode wireless terminal 101 connects with the access point 121 by wireless in a Wireless Local Area Network (WLAN) method, and also performs the data communication through an internet provider system 123. FIG. 1 illustrates one access point 121, however, plural access points 121 are connected with the internet provider system 123. The internet provider system 123 is connected with the internet 111. The multi-mode wireless terminal 101 similarly transmits or receives internet mail by the data communication, and further accesses Web sites. The access point 121 and the internet provider system 123 are portions of a configuration of the telecommunication network for the data communication in the WLAN method.

In order to connect with the internet 111, the multi-mode wireless terminal 101 may connect with any of the telecommunication network for the data communication in the first communication method, the telecommunication network for the data communication in the second communication method, the telecommunication network for the data communication in the third communication method and the telecommunication network for the data communication in the WLAN method.

Moreover, the multi-mode wireless terminal 101 is configured to switch the telecommunication network to be connected while performing the data communication through the internet 111.

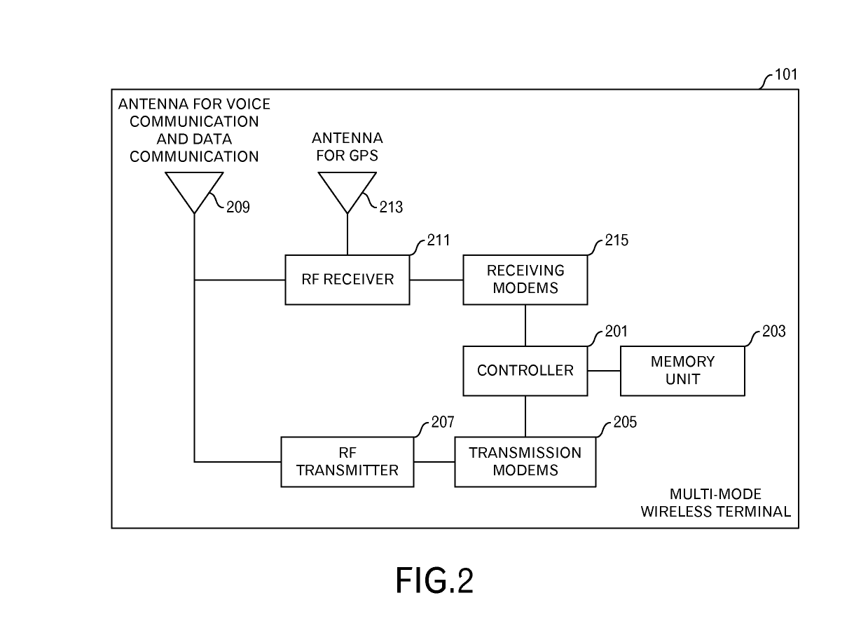

FIG. 2 illustrates an example of a hardware configuration of the multi-mode wireless terminal 101. The multi-mode wireless terminal 101 has a controller 201, a memory unit 203, transmission modems 205, a Radio Frequency (RF) transmitter 207, an antenna 209 for the voice communication and data communication, a RF receiver 211, an antenna 213 for the Global Positioning System (GPS) and receiving modems 215.

The controller 201 controls the transmission modems 205 and receiving modems 215. The controller 201 is connected with the memory unit 203, and reads information to be used, for example, in the control from the memory unit 203, and stores the information obtained by the control into the memory unit 203. The transmission modems 205 includes the transmission modems that follow the respective aforementioned communication methods.

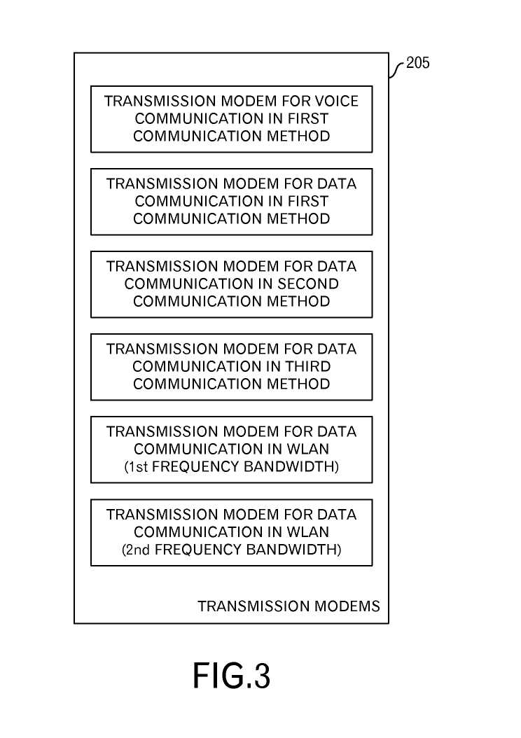

FIG. 3 illustrates an example of a configuration of the transmission modems 205. The transmission modems 205 include a transmission modem for the voice communication in the first communication method, a transmission modem for the data communication in the first communication method, a transmission modem for the data communication in the second communication method, a transmission modem for the data communication in the third communication method, a transmission modem for the data communication in WLAN method (which uses a first frequency bandwidth) and a transmission modem for the data communication in WLAN method (which uses a second frequency bandwidth). In this example, the multi-mode wireless terminal 101 can communicate data in any one of the WLAN methods using the first frequency bandwidth and the second frequency bandwidth.

Returning to the explanation of FIG. 2, the RF transmitter 207 operates so as to output radio waves for the wireless communication. The antenna 209 for the voice communication and the data communication is an antenna for radio waves for the voice communication and the data communication. The RF receiver 211 operates so as to receive radio waves for the wireless communication. The antenna 213 for the GPS is an antenna for receiving the radio waves for the GPS. The receiving modems 215 include receiving modems that follow the aforementioned communication methods.

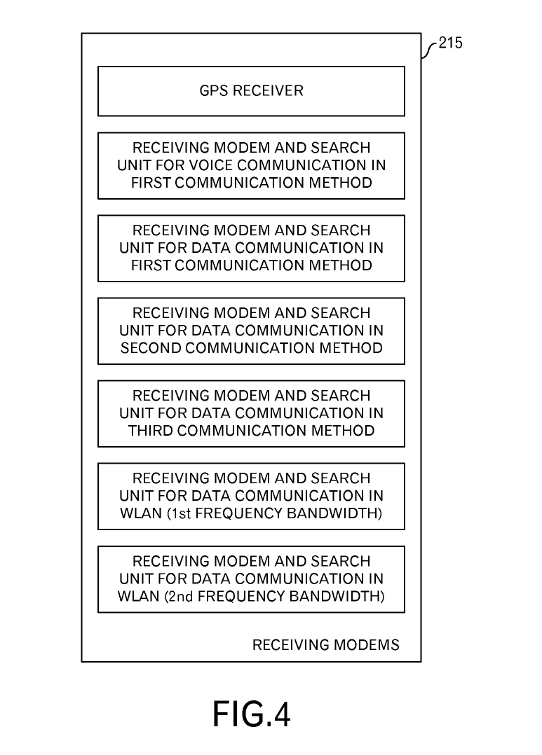

FIG. 4 illustrates an example of a configuration of the receiving modems and the like. The receiving modems 215 include a GPS receiver, a receiving modem and search unit for the voice communication in the first communication method, a receiving modem and search unit for the data communication in the first communication method, a receiving modem and search unit for the data communication in the second communication method, a receiving modem and search unit for the data communication in the third communication method, a receiving modem and search unit for the data communication in the WLAN that uses the first frequency bandwidth and a receiving modem and search unit for the data communication in the WLAN that uses the second frequency bandwidth. The GPS receiver converts radio waves for GPS to position information. The respective search units perform an operation to search the base station or access point in the respective communication method. In this example, the multi-mode wireless terminal 101 searches for the access points in any one of WLAN methods that use the first and second frequency bandwidths, and further receives data.

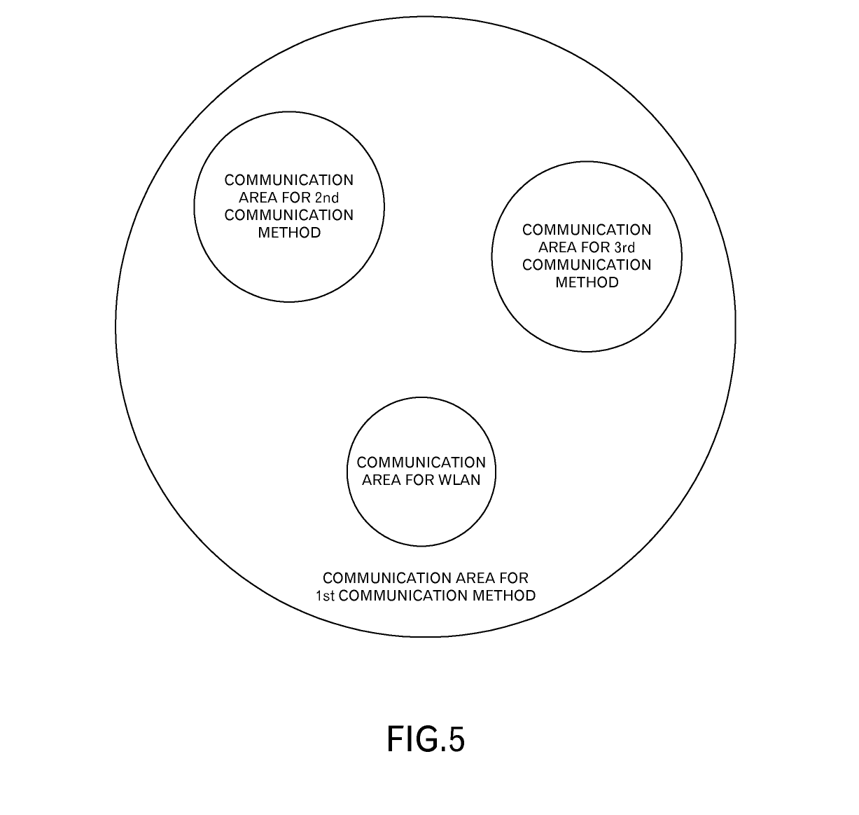

Next, a relationship among communication areas in the respective methods will be explained. FIG. 5 schematically illustrates the communication areas. A first area for the first communication method is a range covered by the first base station 103. Specifically, the first area for the first communication method represents a range that is connectable by radio to the telecommunication network for the voice communication in the aforementioned first communication method and to the telecommunication network for the data communication in the first communication method. Typically, in case of the existing communication method such as EVolution Data Only (EV-DO), the communication area widely covers the area.

The second area for the second communication method represents a range in which the multi-mode wireless terminal 101 is connectable by radio to the telecommunication network for the data communication in the aforementioned second communication method. The third area for the third communication method represents a range in which the multi-mode wireless terminal 101 is connectable by radio to the telecommunication network for the data communication in the aforementioned third communication method. In case of a new communication method such as Long Term Evolution (LTE), the communication area is initially narrow, typically. As another communication method, there is a method such as Worldwide Interoperability for Microwave Access (WiMAX) that covers a middle-range area.

The WLAN communication area represents a range in which the multi-mode wireless terminal 101 is connectable by radio to the telecommunication network for the data communication in the WLAN. A range covered by the access point of the WLAN is typically narrow. However, by providing plural access points, the communication area for the WLAN can be widened.

FIG. 5 illustrates an example of a state in which the existing first area for the first communication method overlaps with the second area for the second communication method, the third area for the third communication method and the communication area for the WLAN.

Thus, the first area for the first communication method includes an area, which is included in a communication area for another communication method, and in which the data communication in another communication method can be made, and an area, which is not included in the communication area for another communication method, and in which the data communication in another communication method cannot be made.

Even in case where the data communication in the first communication method is performed, there is a case where it is preferable for the multi-mode wireless terminal 101, that the data communication method is switched to another communication method, when another communication method is advantageous more than the present communication method in view of the communication condition and/or economic condition. In this embodiment, an example of the multi-mode wireless terminal 101 that is performing the data communication in the first communication method will be explained.

Moreover, in order to confirm whether or not it is possible to connect with the telecommunication network in another communication method, the multi-mode wireless terminal 101 steadily performs an operation to search for the base station or access point. Therefore, there is a problem that the battery in the multi-mode wireless terminal 101 is heavily exhausted.

In order to resolve this problem, the multi-mode wireless terminal 101 in this embodiment obtains information concerning the communication area in another communication method from the first voice communication system 105.

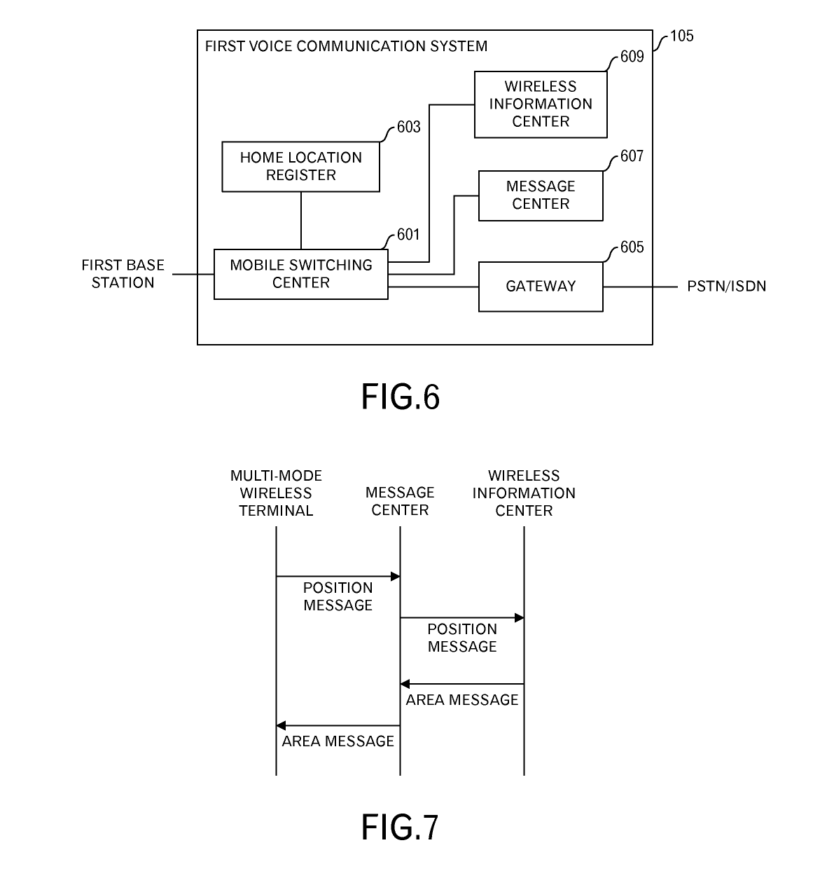

Next, the first voice communication system 105 will be explained. FIG. 6 illustrates an example of a configuration of the first voice communication system 105. The first voice communication system 105 has a mobile switching center 601, a home location register 603, a gateway 605, a message center 607 and a wireless information center 609. The mobile switching center 601 manages the base stations and switches wireless signals. The home location register 603 manages subscriber data. The gateway 605 performs protocol conversion. The message center 607 performs message management. The wireless information center 609 manages information concerning the communication areas for other communication methods.

In this embodiment, the wireless information center 609 provides a message including information concerning the communication areas in other communication methods for the multi-mode wireless terminal 101 through the message center 607.

In the following, an outline of this embodiment will be explained. First, a message flow will be explained. FIG. 7 illustrates an example of a message flow. The multi-mode wireless terminal 101 that desires to obtain information concerning the communication areas transmits a position message to the wireless information center 609. The position message includes information representing the position of the multi-mode wireless terminal 101. The position message is temporarily stored in the message center 607. After that, the message center 607 transfers the position message to the wireless information center 609.

When the wireless information center 609 receives the position message, the wireless information center 609 generates an area message including the communication areas for other communication methods based on information concerning the position of the multi-mode wireless terminal 101, which is included in the position message.

The area message is transmitted to the multi-mode wireless terminal 101, and is returned to the multi-mode wireless terminal 101 through the message center 607. The multi-mode wireless terminal 101 determines, based on the information concerning the communication areas for other communication methods, which is included in the area message, whether or not the search for the base station or access point is required.

In this example, a Short Message Service (SMS) is used, however, internet mail or communication in any of other formats may be used.

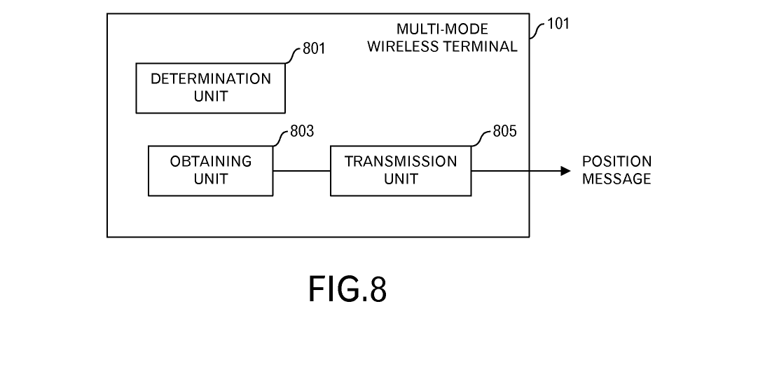

Firstly, an operation relating to transmission of a position message of the multi-mode wireless terminal 101 will be explained. FIG. 8 illustrates a configuration example of functional modules of the multi-mode wireless terminal 101, which relate to the transmission of the position message. The multi-mode wireless terminal 101 has a determination unit 801, an obtaining unit 803 and a transmission unit 805. The determination unit 801 determines a timing to transmit the position message. The obtaining unit 803 obtains position information of the multi-mode wireless terminal 101 from a GPS receiver. The transmission unit 805 transmits the position message to the wireless information center 609.

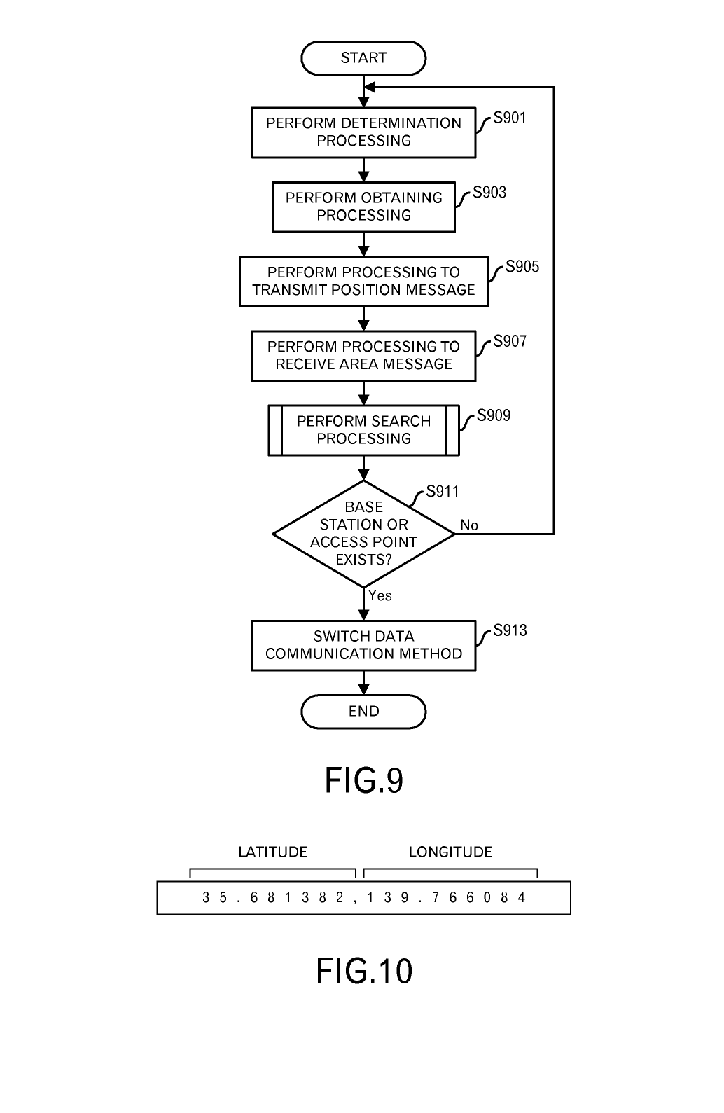

FIG. 9 illustrates an example of a processing flow for the multi-mode wireless terminal 101. First, the determination unit 801 performs a determination processing (S901) to determine a timing to transmit a position message. In order to determine the timing to transmit the position message, a following method is used, for example.

(1) The timing is determined at predetermined intervals by a timer.

(2) When the data communication with any one of telecommunication networks is performed, the timing is identified as the time when the throughput of the receipt in the data communication decreases and does not reach a predetermined threshold.

(3) The timing is identified as the time when the browser is activated.

(4) The timing is identified as the time when the data communication with any one of the telecommunication networks starts.

Next, the obtaining unit 803 performs a processing to obtain information representing a position of the multi-mode wireless terminal 101 from the GPS receiver (S903). When the position of the multi-mode wireless terminal 101 is identified by using other methods such as a measurement method that utilizes the WLAN, the information representing the position of the multi-mode wireless terminal 101 may be obtained by using any one of other methods.

The transmission unit 805 performs a processing to transmit the position message including the information that represents the position of the multi-mode wireless terminal 101 to the wireless information center 609 (S905). FIG. 10 illustrates an example of the position message. The position is identified, for example, by the latitude and longitude. S907 and subsequent processing will be explained later.

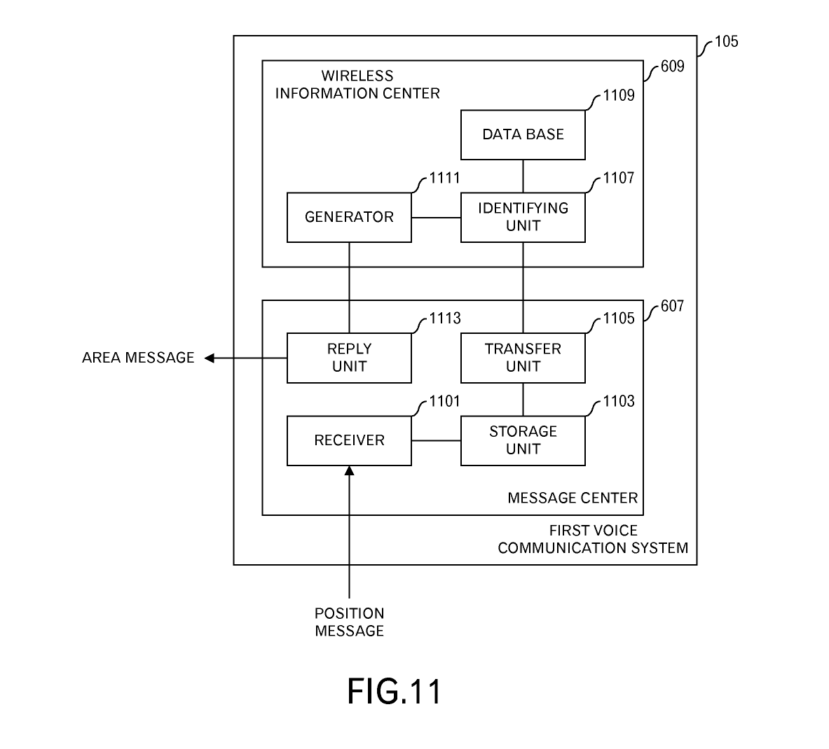

Next, an operation on the side of the first voice communication system 105 will be explained. FIG. 11 illustrates a configuration example of functional modules of the first voice communication system 105. The message center 607 included in the first voice communication system 105 includes a receiver 1101, a storage unit 1103, a transfer unit 1105 and a reply unit 1113. Furthermore, the wireless information center 609 included in the first voice communication system 105 includes an identifying unit 1107, a database 1109 and a generator 1111.

The receiver 1101 receives the position message. The storage unit 1103 temporarily stores the position message. The transfer unit 1105 transfers the position message to the wireless information center 609.

The identifying unit 1107 receives the position message, and identifies information concerning communication areas in other communication methods, based on the information representing the position of the multi-mode wireless terminal 101, which is included in the position message. The database 1109 stores the information concerning the communication areas in other methods. The generator 1111 generates an area message, which includes the information concerning the communication areas in other communication methods and is addressed to the multi-mode wireless terminal 101, and outputs the area message to the message center 607. The reply unit 1113 sends the area message to the multi-mode wireless terminal 101.

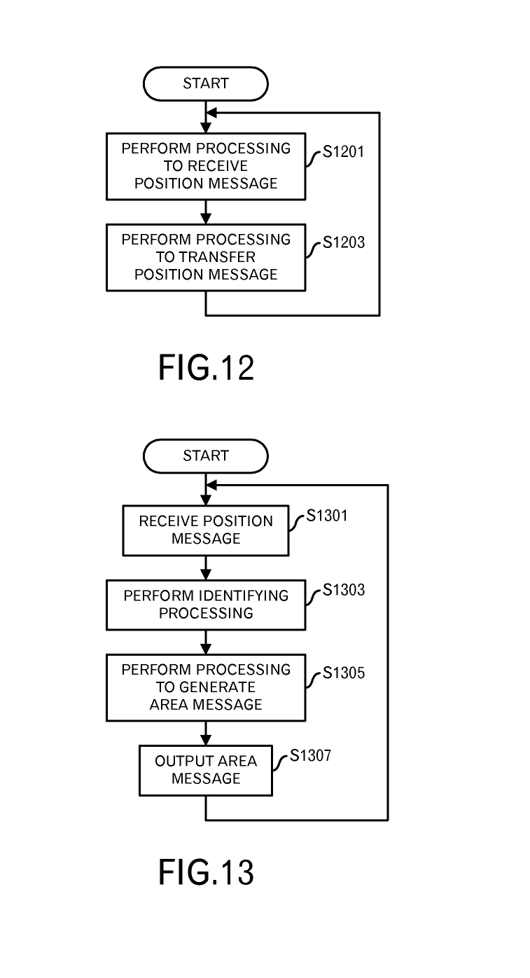

FIG. 12 illustrates an example of a processing flow that relates to the receipt of the position message in the message center 607. The receiver 1101 performs a processing to receive the position message (S1201). Then, the receiver 1101 temporarily stores the received position message into the storage unit 1103. The transfer unit 1105 reads the position message stored in the storage unit 1103, and performs a processing to transfer the position message to the wireless information center 609 (S1203).

FIG. 13 illustrates an example of a processing flow that relates to transmission of the area message in the wireless information center 609. The identifying unit 1107 receives the position message from the message center 607 (S1301), and performs a processing to identify information concerning the communication areas in other communication methods according to the position of the multi-mode wireless terminal 101 (S1303). In this processing, the identifying unit 1107 obtains the information concerning the communication areas in other communication methods from the database 1109.

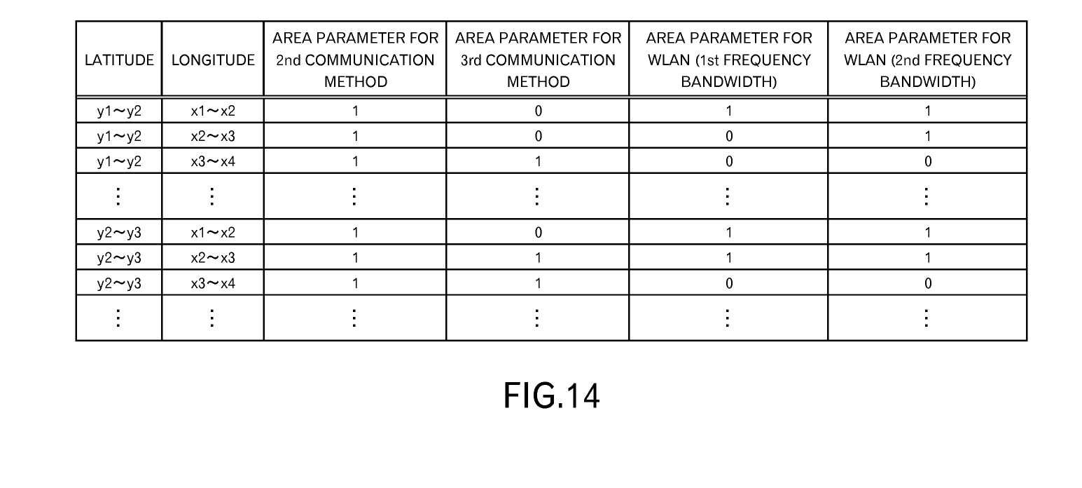

The aforementioned data base 1109 will be explained. FIG. 14 illustrates an example of data stored in the database 1109. The database 1109 stores area parameters of other communication methods in association with a geographical range identified by the latitude and longitude. More specifically, an area parameter for the second communication method, area parameter for the third communication method, area parameter for the WLAN (first frequency bandwidth) and area parameter for the WLAN (second frequency bandwidth) are stored.

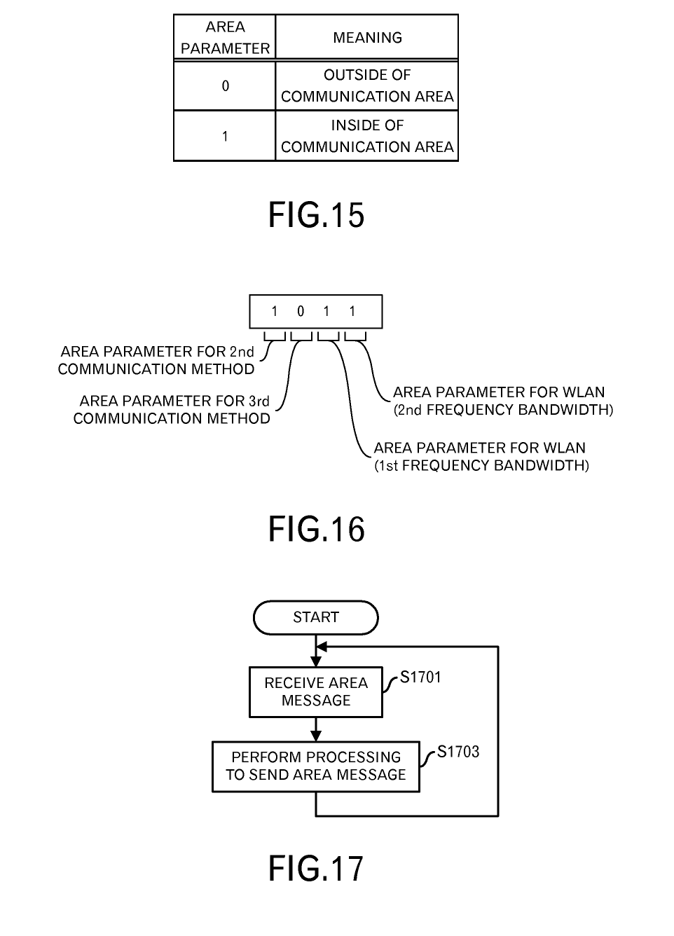

The aforementioned area parameters will be explained. FIG. 15 illustrates an example of area parameters. In this example, the area parameter is represented by 1 bit. The area parameter “0” means the aforementioned geographic range is out of the communication area for that communication method. On the other hand, the area parameter “1” means the aforementioned geographic range is in the communication area for that communication method.

In S1303 in FIG. 13, the identifying unit 1107 identifies the position of the multi-mode wireless terminal 101 from the position message, and identifies a geographical range that includes the position of the multi-mode wireless terminal 101. The identifying unit 1107 reads area parameters for other communication methods, which correspond to the identified geographical range. More specifically, an area parameter for the second communication method, an area parameter for the third communication method, an area parameter for the WLAN (first frequency bandwidth), and an area parameter for the WLAN (second frequency bandwidth) are read.

The generator 1111 performs a processing to generate an area message including the read area parameters for other communication methods (S1305). FIG. 16 illustrates an example of the area message. The area message includes the area parameter for the second communication method, area parameter for the third communication method, area parameter for the WLAN (first frequency bandwidth) and area parameter for the WLAN (second frequency bandwidth).

Returning to FIG. 13, the generator 1111 outputs the area message addressed to the multi-mode wireless terminal 101 to the message center 607 (S1307).

The operation of the message center 607 will be explained in the following. FIG. 17 illustrates an example of a processing flow that relates to transmission of the area message in the message center 607. When the reply unit 1113 in the message center 607 receives the area message from the generator 1111 in the wireless information center 609 (S1701), the reply unit 1113 performs a processing to send the area message to the multi-mode wireless terminal 101 (S1703).

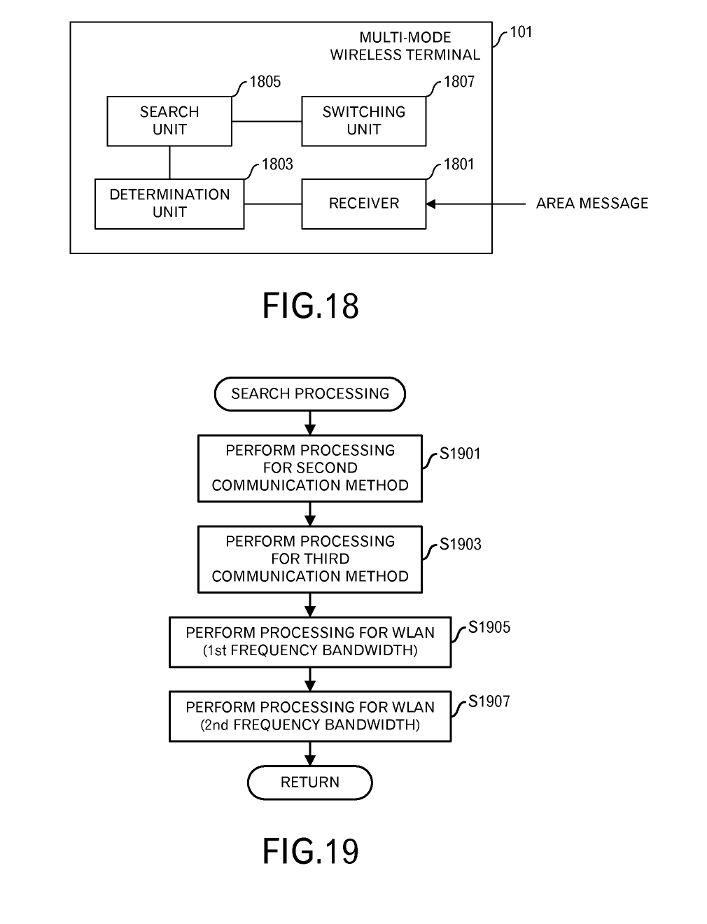

Next, an operation to search the base station or access point by the multi-mode wireless terminal 101 will be explained. FIG. 18 illustrates a configuration example of functional modules in the multi-mode wireless terminal 101, which relate to the search for the base station or access point. The multi-mode wireless terminal 101 includes a receiver 1801, a determination unit 1803, a search unit 1805 and a switching unit 1807.

The receiver 1801 receives the area message. The determination unit 1803 determines whether or not search for the base station or access point is required, based on the area message. The search unit 1805 searches for the base station or access point for each communication method, according to the determination result regarding whether or not the search is required. When the base station or access point is detected as a result of the search, the switching unit 1807 connects with the base station or access point, and switches from the communication with the telecommunication network that is being connected by radio to the communication with the telecommunication network that is newly connected.

As illustrated in FIG. 9, the receiver 1801 performs a processing to receive the area message (S907). Furthermore, the determination unit 1803 performs a search processing to search for the base station or access point for each communication method, according to the determination result regarding whether or not the search is required (S909).

In the following, the aforementioned search processing (S909) will be explained in detail. FIG. 19 illustrates an example of a processing flow that relates to the search for the base station or access point in the multi-mode wireless terminal 101. The determination unit 1803 performs a processing for the second communication method (S1901), a processing for the third communication method (S1903), a processing for the WLAN (first frequency bandwidth) (S1905) and a processing for the WLAN (second frequency bandwidth) (S1907) in sequence. Each of S1901 to S1907, the determination regarding whether or not the search for the base station or access point is required and the search for the base station or access point are performed in each of the communication methods.

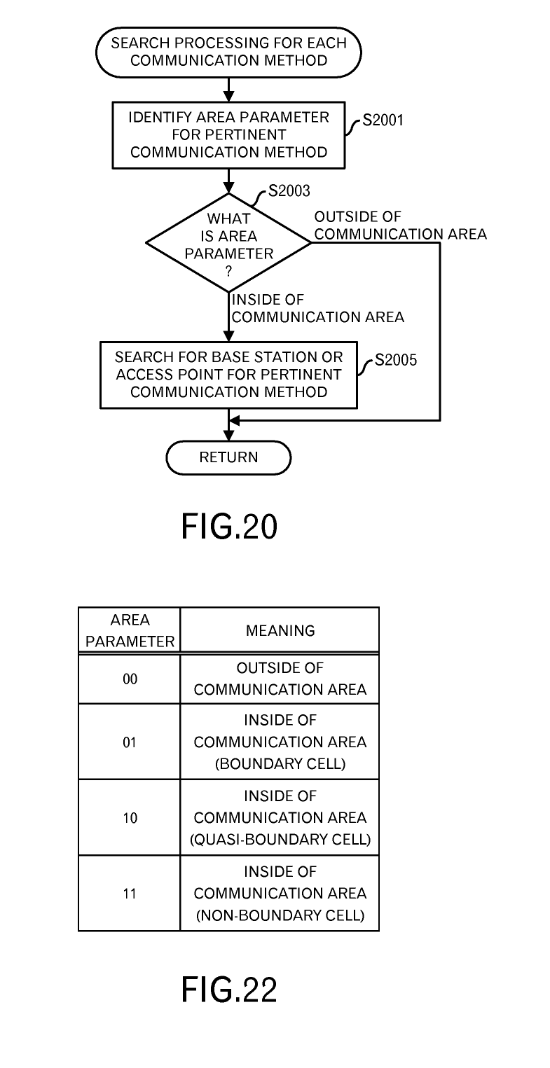

FIG. 20 illustrates an example of a processing flow that relates to the search for the base station or access point in each communication method. This processing is the same as that in each of S1901 to S1907. The determination unit 1803 identifies the area parameter for the pertinent communication method, which is included in the area message (S2001). The determination unit 1803 determines whether the area parameter represents “outside of the communication area” or “inside of the communication area” (S2003). When it is determined that the area parameter represents “outside of the communication area”, the search is not performed. Therefore, the processing ends, and the processing returns to the processing in FIG. 19.

On the other hand, when it is determined that the area parameter represents “inside of the communication area”, the search is performed. Therefore, the determination unit 1803 searches for the base station or access point for the pertinent communication method (S2005), and the processing returns to the processing in FIG. 19.

When the processing up to S1907 in FIG. 19 is completed, the processing returns to the processing in FIG. 9, and it is determined whether or not the base station or access point exists (S911). When it is determined that the base station or access point exists, the switching unit 1807 switches the data communication method (S913). More specifically, the switching unit 1807 connects to the detected base station or access point and switches the communication from the communication with the telecommunication network that is being connected by radio to the communication with the telecommunication network that is newly connected. Then, the processing ends.

When plural base stations or access points are detected, one base station or access point to be connected may be selected according to a preset priority. Or, when one base station or access point is detected, the search is terminated, and the connection with the detected base station or access point is established to switch the data communication to the communication with detected the base station or access point.

According to this embodiment, when the wireless terminal is outside of the communication area, the search for the base station or access point that relays data to the telecommunication network is omitted. Therefore, the power consumption required for the search in which the possibility to detect the base station or access point is low is suppressed, and the driving period of the battery is prolonged. Especially, it is possible to avoid the repeat of the search at a position where the base station or access point does not exist.

Moreover, according to this embodiment, when the wireless terminal is inside of the communication area, the search for the base station or access point is performed, because the possibility that the base station or access point can be detected is high. Accordingly, the efficient power consumption is conducted.

### Embodiment 2

In the aforementioned first embodiment, an example was explained in which it is determined whether or not the search is required, based on whether the wireless terminal is out of the communication area or within the communication area. In this embodiment, an example will be explained in which the inside of the communication area is identified in detail. More specifically, it is identified whether or not the wireless terminal is near the boundary with the outside and within the communication area.

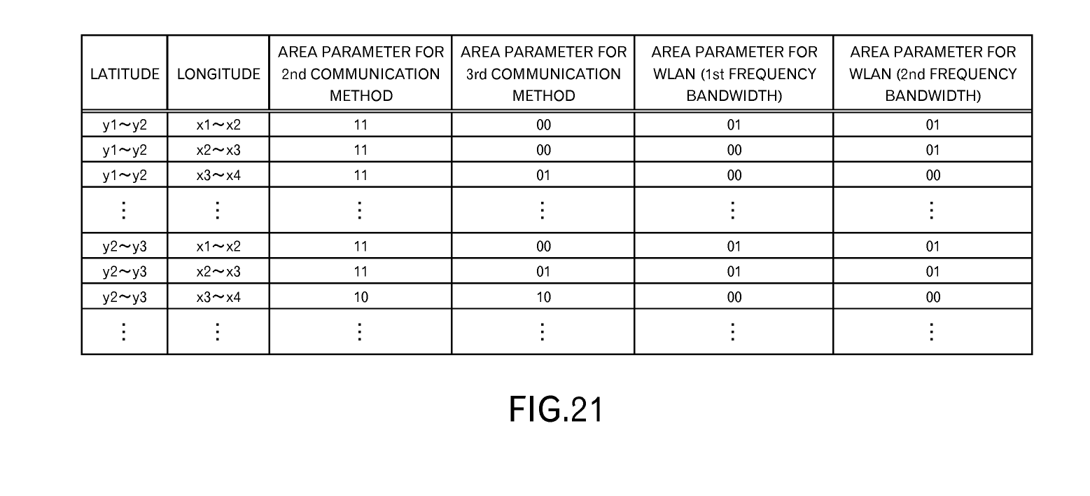

FIG. 21 illustrates an example of a database relating to this embodiment. Similarly to the first embodiment, the geographical area identified by the latitude and longitude is associated with an area parameter for each communication method. However, each area parameter includes 2 bits, and represents one of four values.

FIG. 22 illustrates example of the area parameters relating to the second embodiment. “00” means “outside of the communication area”. “01” means “inside of the communication area”, but especially, “within a cell (hereinafter, referred to boundary cell) of a boundary with the outside”. “10” means “inside of the communication area”, but especially, “within a cell (hereinafter, referred to quasi-boundary cell) that is near the boundary, but inside than the boundary cell”. For example, the quasi-boundary cell may be defined as a cell that contacts with the boundary cell and is not the boundary cell. “11” means “inside of the communication area”, but “within a cell (hereinafter, referred to non-boundary cell) far away from the boundary”. In this example, the non-boundary cell means “inside of the communication area” and “within a cell that is not either of the boundary cell and quasi-boundary cell”.

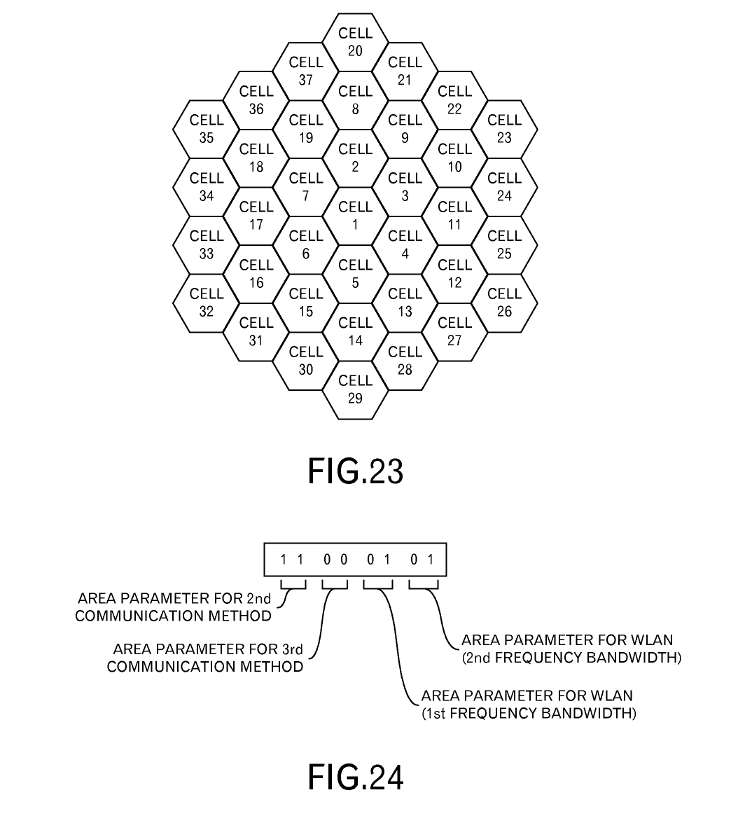

FIG. 23 illustrates an example of a communication area. When presuming that the communication area includes cells 1 to 37, cells 20 to 37 corresponding to an outer circumference are boundary cells. Cells 8 to 19, which are inside than the boundary cells, correspond to the quasi-boundary cells. On the other hand, cells 1 to 7 that is not either of the boundary cells and quasi-boundary cells correspond to the non-boundary cells.

Next, the area message in this embodiment will be explained. FIG. 24 illustrates an example of the area message relating to the second embodiment. The area parameters within the area message follow the aforementioned example. In this figure, the area parameter of the second communication method is “11”, and represents that the wireless terminal is within the communication area and in the non-boundary cell. The area parameter of the third communication method is “00”, and represents that the wireless terminal is outside of the communication area. The area parameter of each of the WLAN (first frequency bandwidth) and WLAN (second frequency bandwidth) is “01”, and represents that the wireless terminal is within the communication area and within the boundary cell.

In order to generate the area message, the identifying unit 1107 obtains a 2-bit area parameter from the database 1109 at S1303 in FIG. 13.

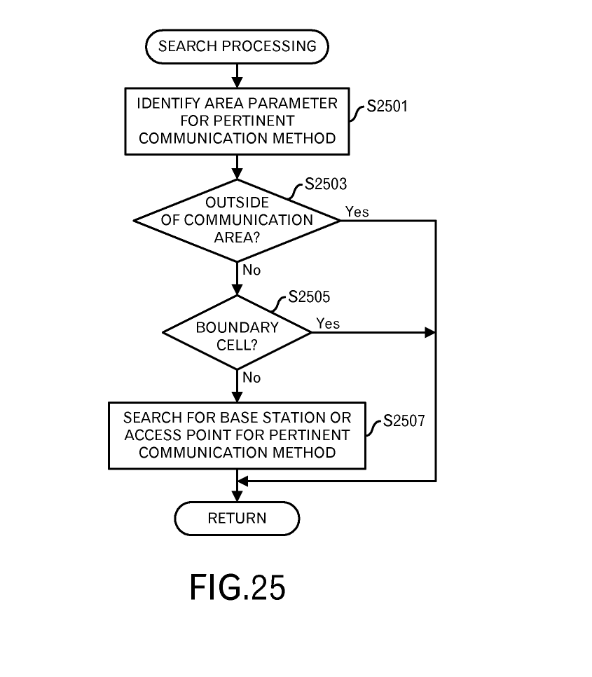

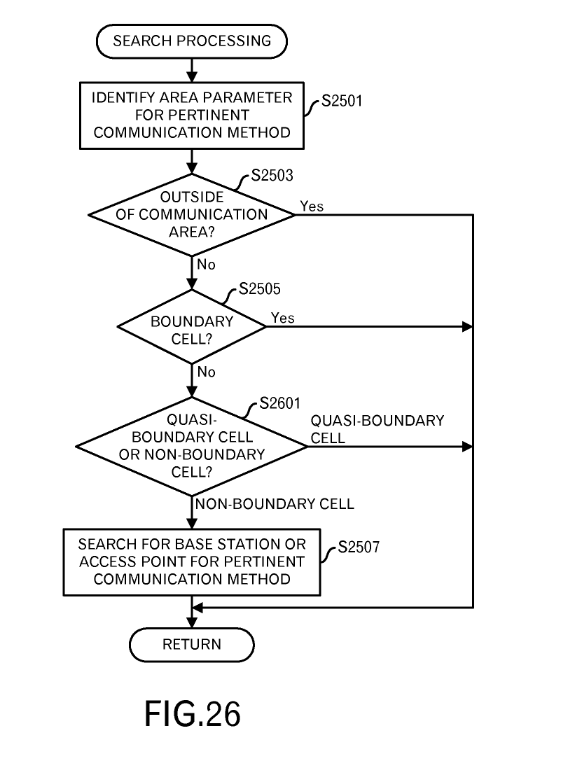

Next, a processing that relates to the search for the base station or access point for each communication method within the processing of the wireless information center 609 will be explained. FIGS. 25 to 29 illustrate 5 examples. In FIG. 25, an example is illustrated in which the search for the base station or access point is omitted, when the wireless terminal is in the boundary cell. In FIG. 26, an example is illustrated in which the search for the base station or access point is omitted in the boundary cell and quasi-boundary cell. Both are examples that the search is omitted when the wireless terminal is near the boundary.

In a processing flow in FIG. 25, the determination unit 1803 identifies an area parameter for the pertinent communication method (S2501), and determines whether or not the area parameter represents “outside of the communication area” (S2503). When it is determined that the area parameter represents “outside of the communication area”, the search is omitted and the processing ends. On the other hand, when it is determined that the area parameter does not represent “outside of the communication area”, the determination unit 1803 further determines whether or not the area parameter represents within the boundary cell (S2505). When it is determined that the area parameter represents “within the boundary cell”, the search is omitted and the processing ends. When it is determined that the area parameter does not represent “within the boundary cell”, the search unit 1805 searches for the base station or access point for the pertinent communication method (S2507).

Next, an example illustrated in FIG. 26 will be explained. The determination unit 1803 identifies an area parameter for the pertinent communication method (S2501), and determines whether or not the area parameter represents “outside of the communication area” (S2503), and determines whether or not the area parameter represents “within the boundary cell” (S2505), similarly to the processing in FIG. 25.

In this example, when it is determined that the area parameter does not represent “within the boundary cell”, the determination unit 1803 determines whether the area parameter represents “within the quasi-boundary cell” or “within the non-boundary cell” (S2601). When it is determined that the area parameter represents “within the quasi-boundary cell”, the search is omitted and the processing ends. When it is determined that the area parameter represents “within the non-boundary cell”, the search unit 1805 searches for the base station or access point for the pertinent communication method (S2507). In this example, the quasi-boundary cell is also handled as being near the boundary.

Thus, when the wireless terminal is near the boundary, the search for the base station or access point is omitted. Therefore, in a situation that, even if the connection with the relay station or access point is established, the communication may be interrupted due to the movement of the wireless terminal, it is possible to reduce the power consumed by the search for the base station or access point.

“Near the boundary” means a range including the boundary. However, how wide the width is arbitrarily determined. In FIG. 25, the width corresponds to one cell, and in FIG. 26, the width corresponds to two cells. However, wider width may be employed. Moreover, instead of the cell unit, the length from the boundary may be employed.

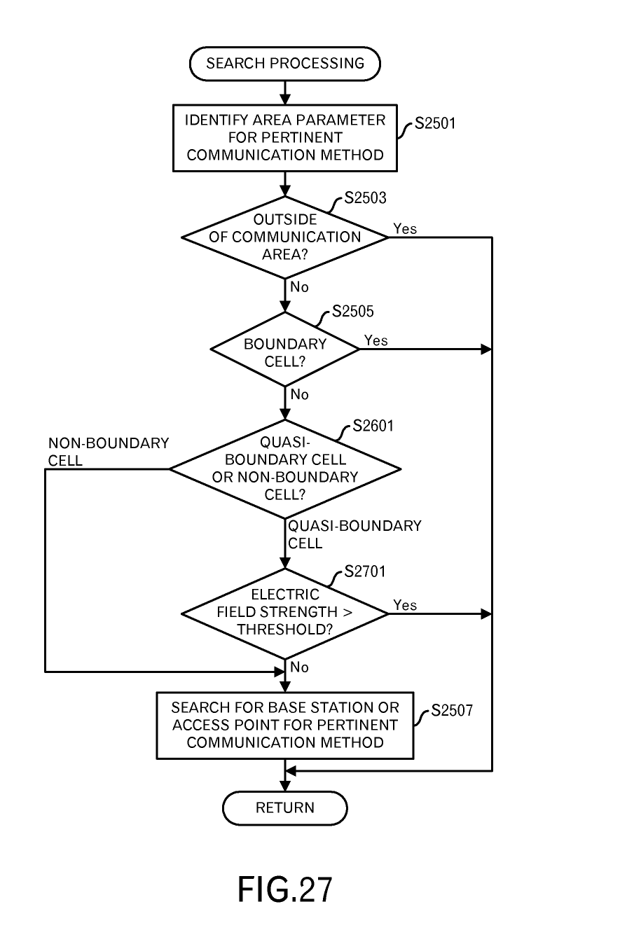

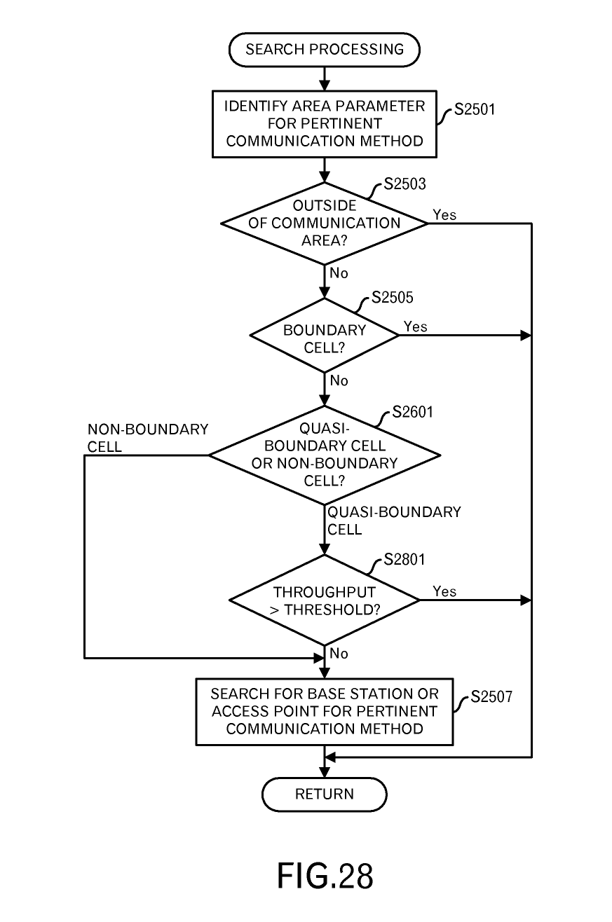

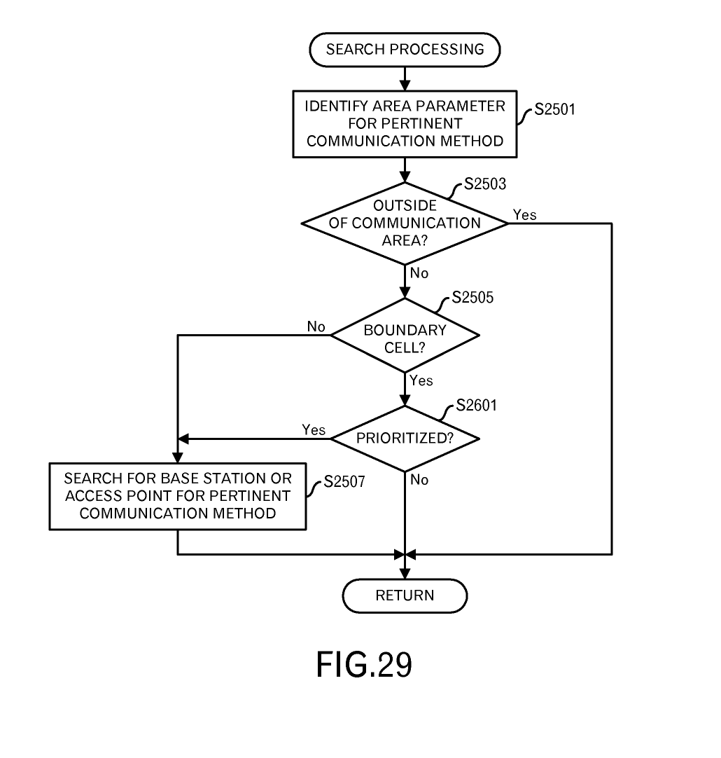

Next, in FIG. 27, an example will be explained in which the search is omitted when the wireless terminal is near the boundary and the electric field strength exceeds the threshold. By using FIG. 28, an example will be explained in which the search is omitted when the wireless terminal is near the boundary and the throughput exceeds the threshold. By using FIG. 29, an example will be explained in which the search is omitted when the wireless terminal is near the boundary and the pertinent communication method is not prioritized. In any example of FIGS. 27 to 29, it is determined whether or not the search is omitted, based on a condition set in the multi-mode wireless terminal 101, when the wireless terminal is near the boundary.

An example of a processing flow illustrated in FIG. 27 will be explained. The processing from S2501 to S2601 is the same as the processing in FIG. 26. However, when it is determined at S2601 that the wireless terminal is in the quasi-boundary cell, the current communication state is determined. More specifically, the determination unit 1803 determines whether or not the strength of the received electric waves, in other words, the electric field strength exceeds a predetermined threshold (S2701). For example, the threshold is −90 dB. When it is determined that the electric field strength exceeds the predetermined threshold, the present communication state is good, so the search is omitted and the processing ends. On the other hand, when it is determined that the electric field strength does not exceed the predetermined threshold, the search unit 1805 searches for the base station or access point for the pertinent communication method (S2507). In the boundary cell, the determination of the electric field strength may be made.

Next, an example of a processing flow in FIG. 28 will be explained. The processing of S2501 to S2601 is the same as that in FIG. 26. However, when it is determined at S2601 that the wireless terminal is in the quasi-boundary cell, the present communication state is determined. More specifically, the determination unit 1803 determines whether or not the throughput of the receipt exceeds a predetermined threshold (S2801). The threshold is 1 Mbps, for example. When it is determined that the throughput exceeds the predetermined threshold, the present communication state is good, so the search is omitted, and the processing ends. On the other hand, when it is determined that the throughput does not exceed the predetermined threshold, the search unit 1805 searches for the base station or access point for the pertinent communication method (S2507). In the boundary cell, the determination of the throughput of the receipt may be made.

When the state of the wireless communication with the second telecommunication network is good, it is possible to suppress the power consumption by omitting the search for the base station or access point.

Next, an example of a processing flow in FIG. 29 will be explained. The processing of S2501 to S2505 is the same as that in FIG. 25. However, when it is determined at S2505 that the wireless terminal is in the boundary cell, the determination unit 1803 determines whether or not the telecommunication network for the pertinent communication method is set as being prioritized (S2901). When it is determined that the telecommunication network for the pertinent communication network is not set as being prioritized, the search is omitted and the processing ends. On the other hand, when it is determined that the telecommunication network for the pertinent communication network is set as being prioritized, the search unit 1805 searches for the base station or access point for the pertinent communication method (S2507). In the quasi-boundary cell, the determination of the priority setting may be conducted.

Thus, the search for the base station or access point of the telecommunication network that has a low priority is omitted, so it is possible to suppress the power consumption.

Two or more of the aforementioned conditions such as the electric field strength, throughput and priority may be combined, arbitrarily. The conditions may be combined by AND or OR. In FIGS. 27 to 29, when the wireless terminal is near the boundary and the condition for which the wireless terminal is set is satisfied, the search for the base station or access point is omitted. Therefore, in a situation that, even if the connection with the relay station or access point is established, the connection may be interrupted due to the movement of the wireless terminal, it is possible to appropriately reduce the power consumed by the search for the base station or access point according to the condition set for which the wireless terminal.

### Embodiment 3

In this embodiment, an example will be explained in which the result of the search in the multi-mode wireless terminal 101 is sent to the first voice communication system 105 to update the database 1109.

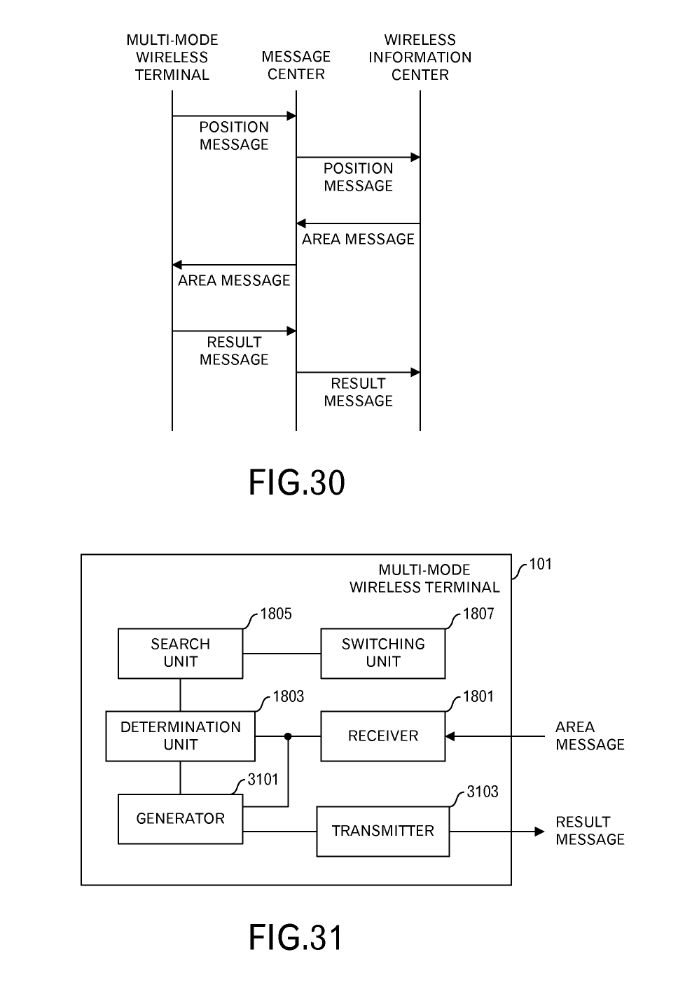

FIG. 30 illustrates an example of a message flow relating to the third embodiment. The flow of the position message and the area message is the same as the message flow in the first embodiment described in FIG. 7.

In this embodiment, the multi-mode wireless terminal 101 transmits a result message including the result of the search to the wireless information center 609. The result message is temporarily stored in the message center 607, similarly to the case of the position message and transferred to the wireless information center 609 later.

FIG. 31 illustrates a configuration example of functional modules of the multi-mode wireless terminal 101 relating to the third embodiment. The multi-mode wireless terminal 101 includes a generator 3101 and a transmitter 3103 in addition to the receiver 1801, determination unit 1803, search unit 1805 and switching unit 1807. The generator 3101 generates the result message. The transmitter 3103 transmits the result message to the wireless information center 609.

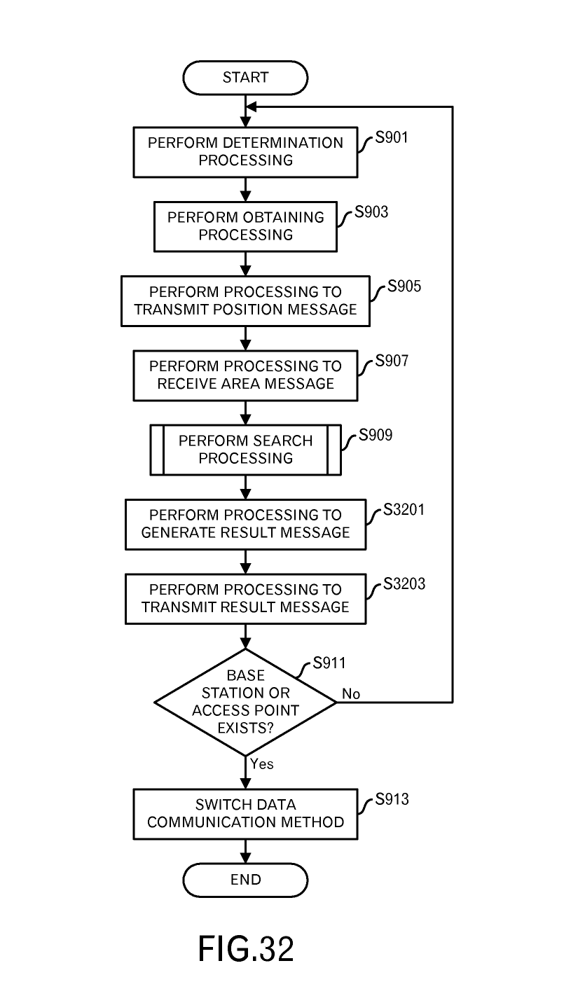

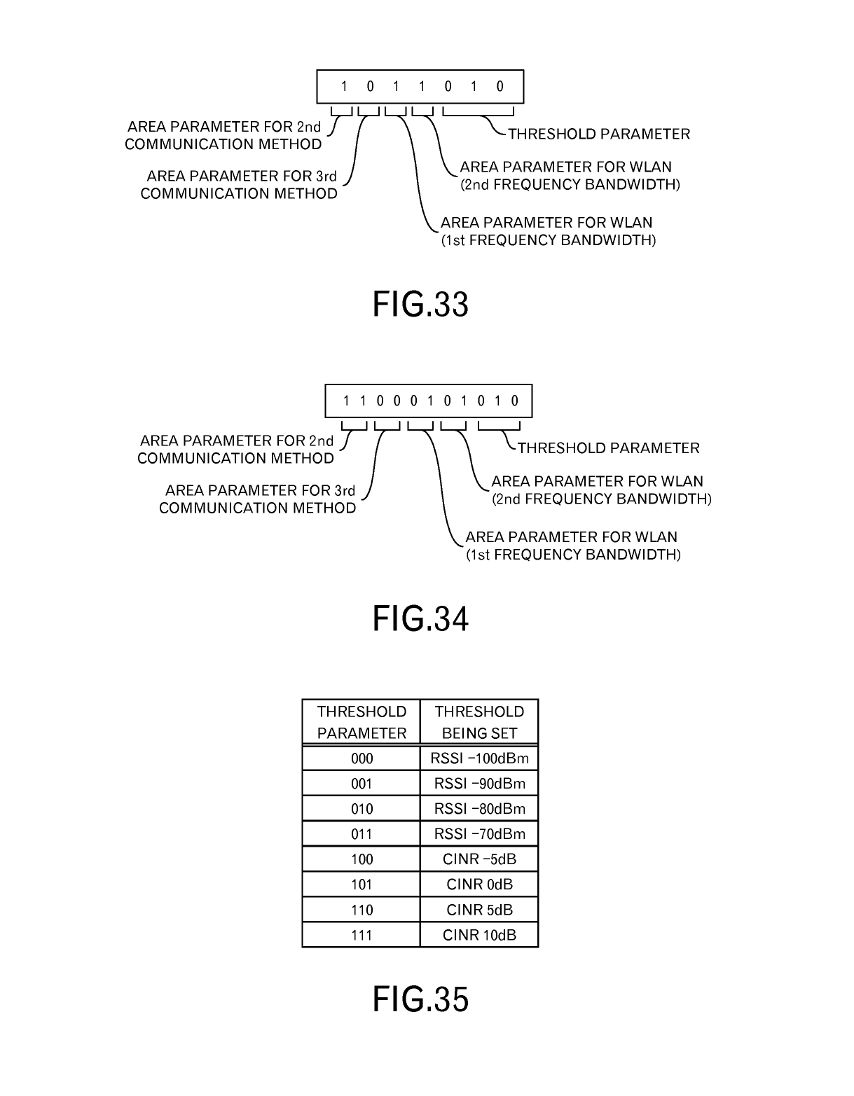

FIG. 32 illustrates an example of a processing flow by the multi-mode wireless terminal 101 relating to the third embodiment. The processing (S901) executed by the determination unit 801, processing executed by the obtaining unit 803 (S903), processing (S905) to transmit the position message, which is executed by the transmission unit 805, processing (S907) to receive the area message, which is executed by the receiver 1801 and search processing (S909) executed by the determination unit 1803 are the same as those in the processing flow illustrated in FIG. 9, which relates to the aforementioned embodiments.

In this embodiment, next to the search processing (S909), the generator 3101 perform a processing to generate the result message (S3201). The generator 3101 obtains a search result by comparing parameters regarding the receiving state with thresholds to generate the result message including the search result. The thresholds used for this are designated by the first voice communication system 105. More specifically, the area message includes the thresholds as parameters.

The area message relating to this embodiment will be explained. FIG.

33 illustrates an area message in case of using 1-bit area parameters. The area parameter for the second communication method, area parameter for the third communication method, area parameter for the WLAN (first frequency bandwidth) and area parameter for the WLAN (second frequency bandwidth) are the same as those in FIG. 16 that is related to the aforementioned embodiments. In this embodiment, the threshold parameters are further added.

FIG. 34 illustrates an example of an area message in case of using 2-bit area parameters. The area parameter for the second communication method, area parameter for the third communication method, area parameter for the WLAN (first frequency bandwidth) and area parameter for the WLAN (second frequency bandwidth) are the same as those in FIG. 24 that is related to the aforementioned embodiments. In this embodiment, the threshold parameter is added.

FIG. 35 illustrates an example of the threshold parameters. Receiver Signal Strength Indication (RSSI) represents the strength of the received signal. In this drawing, “000” represents, as the threshold, −100 dBm for RSSI. “001” represents, as the threshold, −90 dBm for RSSI. “010” represents, as the threshold, −80 dBm for RSSI. “011” represents, as the threshold, −70 dBm for RSSI. Carrier to Interference and Noise Ratio (CINR) represents the clearness of the radio wave. In this drawing, “100” represents, as the threshold, −5 dB for CINR. “101” represents, as the threshold, 0 dB for CINR. “110” represents, as the threshold, 5 dB for CINR. “111” represents, as the threshold, 10 dB for CINR.

When the measurement value (in this example, RSSI or CINR) of the received signal in the search exceeds the threshold designated by the threshold parameter, the generator 3101 determines that the base station or access point by the search was detected, and sets “1” that represents that the base station or access point was detected to the result message. When the measurement value (in this example, RSSI or CINR) of the received signal in the search does not exceed the threshold designated by the threshold parameter, the generator 3101 determines that the base station or access point is not detected by the search, and sets “0” that represents no detection to the result message. At that time, “1” that represents that it is valid is set to a mask bit for the pertinent communication method. Thus, the search result for the pertinent communication method is represented as being valid. As for the communication method for which the search is not performed, “0” that represents that it is invalid is set to a mask bit for the pertinent communication method.

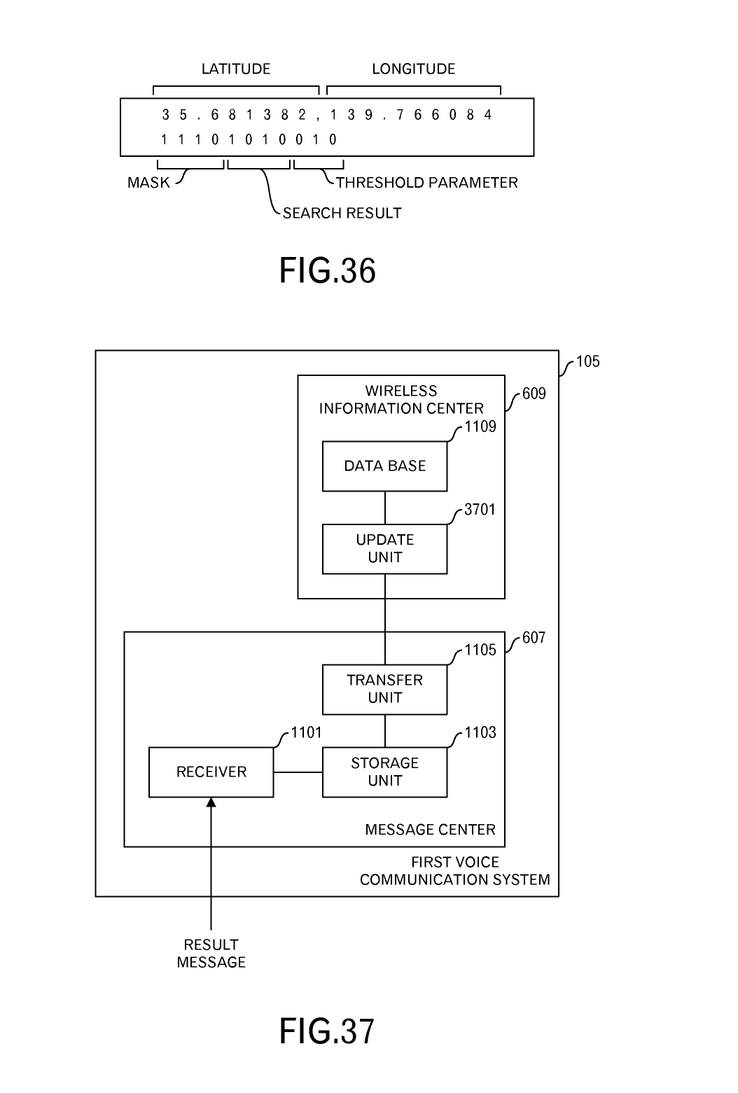

FIG. 36 illustrates an example of the result message. The latitude and longitude represent the position of the multi-mode wireless terminal 101. The mask represents whether or not the search result for each communication method is valid, by using the bit. In other words, in case of the mask bit being “1”, the search result for the pertinent communication method is valid, and in case of the mask bit being “0”, the search result for the pertinent communication method is invalid. In the example of FIG. 36, the mask is “1110”, so the search results for the second communication method, third communication method and WLAN (first frequency bandwidth) are valid, and the respective search results are “1” representing “detected”, “0” representing “not detected” and “1” representing “detected”. The search result for the WLAN (second frequency bandwidth) is invalid. The threshold parameter is the threshold parameter that was used in the determination, and the same as the threshold parameters included in the aforementioned area message.

When the result message is generated, the processing returns to the processing in FIG. 32. The transmitter 3103 performs a processing to transmit the result message to the wireless information center 609 (S3203). S911 and S913 that follow S3203 are the same as those in FIG. 9 that relates to the aforementioned embodiments.

The processing to generate the result message, which is executed by the generator 3101, and processing to transmit the result message, which is executed by the transmitter 3103, may be performed after S913 executed by the switching unit 1807.

Next, an operation on the side of the first voice communication system 105, which receives the result message and updates the database 1109, will be explained. FIG. 37 illustrates a configuration example of the first voice communication system 105 relating to the third embodiment. The wireless information center 609 in the first voice communication system 105 further includes the update unit 3701. The update unit 3701 updates the database 1109 based on the result message.

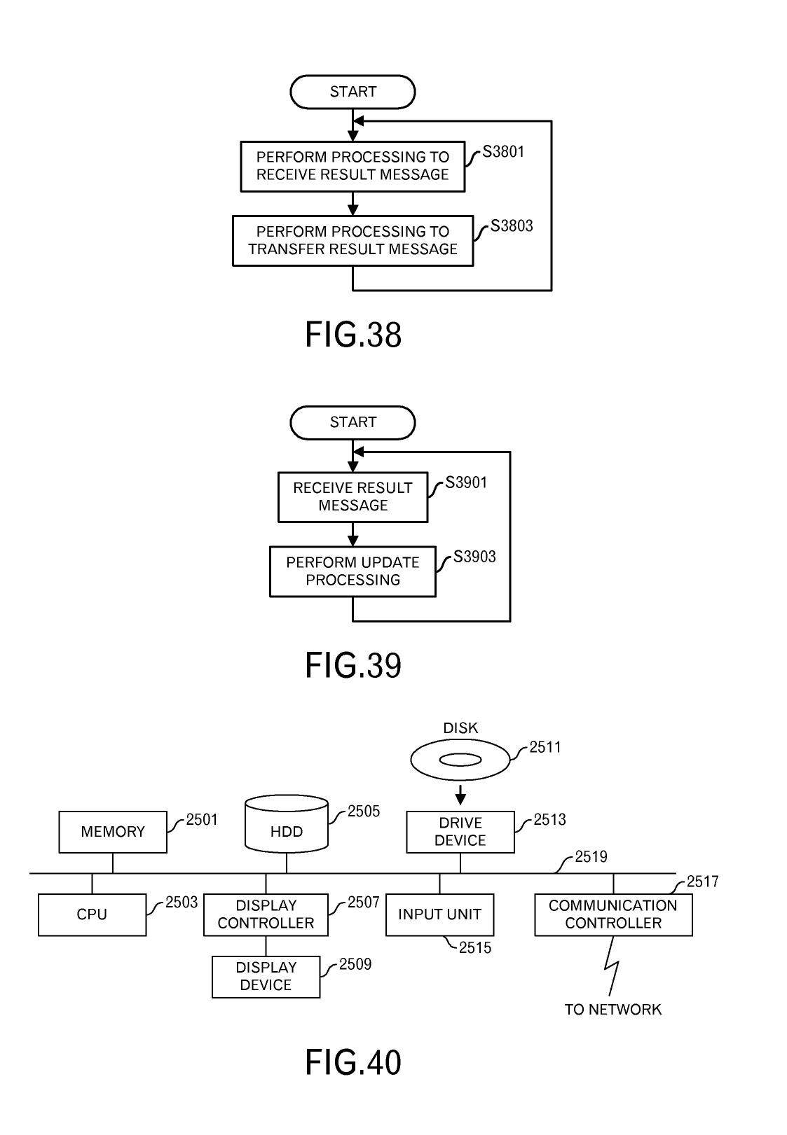

First, an operation in the message center 607 will be explained. FIG. 38 illustrates an example of a processing flow that relates to the receipt of the result message by the message center 607. The receiver 1101 performs a processing to receive the result message (S3801). The receiver 1101 temporarily stores the received result message into the storage unit 1103. The transfer unit 1105 performs a processing to transfer the result message stored in the storage unit 1103 to the update unit 3701 (S3803).

Next, an operation of the wireless information center 609 will be explained. FIG. 39 illustrates an example of a processing flow that relates to update of the database in the wireless information center 609. The update unit 3701 receives the result message (S3901). Then, the update unit 3701 performs a processing to update the database 1109 based on the result message (S3903).

In S3903, the update unit 3701 identifies the position of the multi-mode wireless terminal 101, which is included in the result message, identifies a record corresponding to the position of the multi-mode wireless terminal 101, and updates the area parameter for each communication method. At that time, only in case where the mask bit is “1” representing “valid”, the update is performed, and in case where the mask bit is “0” representing “invalid”, the update is not performed.

First, a case where the area parameter is 1 bit will be explained. When the search result is “1” representing “detected”, “1” representing “inside of the communication area” is set as the area parameter, and when the search result is “0” representing “not detected”, “0” representing “outside of the communication area” is set as the area parameter. Moreover, the area parameter may be updated only when a predetermined number of search results are collected and a ratio of the identical search results is equal to or greater than a predetermined ratio (e.g. 70%).

A case where the area parameter uses 2 bits will be explained. For example, when the area parameter is “00” representing “outside of the communication area” and the search result is “1” representing “detected”, the area parameter is updated to “01” representing “inside of the communication area (boundary cell)”, and when the area parameter is “01” representing “inside of the communication area (boundary cell)” and the search result is “0” representing “not detected”, the area parameter is updated to “00” representing “outside of the communication area”. As for the other cases, the area parameter is not updated. This is because the possibility that the situation is changed is low, when the area parameter is “10” representing “inside of the communication area (quasi-boundary cell)” or when the area parameter is “11” representing “inside of the communication area (non-boundary cell)”.

Moreover, the search is not performed at the position whose area parameter is “00” representing “outside of the communication area” and no information is collected. Therefore, in order to investigate the position, it maybe effective that the area parameter is changed to “01” representing “inside of communication area (boundary cell)” intentionally.

Moreover, as the search results, the measurement values themselves (e.g. RSSI, CINR or the like) may be included in the result message as they are. In such a case, the update unit 3701 may process the collected measurement results statistically to update the database 1109.

According to this configuration, the communication system of the telecommunication network can collect information concerning the communication area of other telecommunication networks.

Furthermore, it is possible to inform the wireless terminal that is connecting with the telecommunication network by radio of information that is useful to determine whether or not it is possible to connect with other telecommunication networks by radio, and it is possible to suppress the power consumption by the wireless terminal that intends to switch the telecommunication network during the communication.

In the aforementioned example, the first voice communication system 105 provides information concerning the communication area for the multi-mode wireless terminal 101. However, instead of the first voice communication system 105, the first data communication system 109, second data communication system 115, third data communication system 119 or internet provider system 123 may provide the information concerning the communication area for the multi-mode wireless terminal 101. In other words, the first data communication system 109, second data communication system 115, third data communication system 119 or internet provider system 123 may include the configuration of the first voice communication system 105, and the multi-mode wireless terminal 101 may transmit the position message to the first data communication system 109, second data communication system 115, third data communication system 119 or internet provider system 123. Moreover, the first data communication system 109, second data communication system 115, third data communication system 119 or internet provider system 123 may return the area message to the multi-mode wireless terminal 101, and the multi-mode wireless terminal 101 may transmit the result message to the first data communication system 109, second data communication system 115, third data communication system 119 or internet provider system 123. In such a case, similarly to the aforementioned embodiments, the short message may be used. Or the position message, area message and result message are transmitted as an internet mail. Or other data transmission or transfer methods maybe used. Moreover, two or more of the short message, internet mail and other data transmission or transfer methods may be combined.

Moreover, when the position of the multi-mode wireless terminal 101 can be identified on the side of the communication system such as the first voice communication system 105, the transmission of the position message from the multi-mode wireless terminal 101 may be omitted.

Moreover, when the multi-mode wireless terminal 101 can identify the position relationship with the communication areas, the transmission of the area message in the communication system such as the first voice communication system 105 may be omitted.

Although the embodiments of this technique were explained above, this technique is not limited to those. For example, the aforementioned functional block configurations may not correspond to program module configurations.

Moreover, the configuration of the storage areas that were explained above is a mere example, and another configuration may be employed to store similar data. Furthermore, as for the processing flows, as long as the processing results do not change, the turn of the steps maybe exchanged, and plural steps may be executed in parallel.

In addition, the aforementioned message center 607 and wireless information center 609 are computer devices as illustrated in FIG. 40. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as illustrated in FIG. 40. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the application programs systematically cooperate with each other, so that various functions as described above in details are realized.

The aforementioned embodiments are outlined as follows:

A wireless terminal relating to a first aspect of the embodiments includes a determination unit that determines whether or not the wireless terminal is outside of a communication area that is connectable with a first telecommunication network by radio; and a search unit that omitting, upon determining that the wireless terminal is outside of the communication area, search for a base station or access point that relays communication with the first telecommunication network.

By employing such a configuration, it is possible to suppress the power consumption required for the search whose possibility that the base station or access point is detected is low, and to prolong the driving period of the battery. Especially, it is also possible to avoid the repetition of the search at a position where the base station or access point does not exist.

Moreover, the aforementioned determination unit may further identify that the wireless terminal is inside of the communication area, and the search unit may further search for the base station or access point upon identifying that the wireless terminal is inside of the communication area.

Thus, it is possible to search for the base station or access point when the possibility that the base station or access point is detected is high, and to effectively use the power.

Moreover, the wireless terminal may further include a switching unit that connects to the base station or the access point, upon detecting the base station or the access point, and switches from communication with a second telecommunication network that is being connected by radio to communication with the first telecommunication network.

Thus, when switching to the communication with the first telecommunication network during the communication with the second telecommunication network, it is possible to effectively search for the base station or access point for the first telecommunication network to suppress the power consumption.

Furthermore, the aforementioned determination unit may further identify that the wireless terminal is near a boundary with the outside of the communication area; and the search unit may omit the search for the base station or the access point, upon determining that the wireless terminal is near the boundary with the outside of the communication area.

Thus, in a situation that, even when connecting to the relay station or access point, the communication may be interrupted due to the movement of the wireless terminal, it is possible to reduce the power consumed by the search for the base station or access point.

Furthermore, the aforementioned determination may further identify that the wireless terminal is near a boundary with the outside of the communication area, and the search unit may further omit the search for the base station or access point upon detecting that the wireless terminal is near the boundary with the outside of the communication area and the condition set for the wireless terminal is satisfied.

Thus, in a situation that, even when connecting to the relay station or access point, the communication may be interrupted due to the movement of the wireless terminal, it is possible to appropriately reduce the power consumed by the search for the base station or access point according to the condition set for the wireless terminal.

Moreover, the aforementioned determination unit may further identify that the wireless terminal is near a boundary with the outside of the communication area, and the search unit may further omit the search for the base station or access point upon detecting that the wireless terminal is near the boundary with the outside of the communication area and a condition concerning a state of communication with the second telecommunication network is satisfied.

Thus, in a situation that, even when connecting with the relay station or access point, the communication may be interrupted due to the movement of the wireless terminal, it is possible to appropriately reduce the power consumed by the search for the base station or access point according to the state of the wireless communication with the second telecommunication network. For example, when the state of the wireless communication with the second telecommunication network is good, it is possible to suppress the power consumption by omitting the search for the base station or access point.

Moreover, the aforementioned condition may be a condition to select a telecommunication network to be connected.

Thus, in a situation that, even when connecting to the relay station or access point, the communication may be interrupted due to the movement of the wireless terminal, it is possible to omit the search for the base station or access point of the telecommunication network whose priority is low, for example, to suppress the power consumption.

Moreover, the wireless terminal may further include a receiver that receives first information that represents a relationship between the wireless terminal and the communication area, and the determination unit determines based on the first information whether or not the wireless terminal is outside of the communication area.

By employing such a configuration, it is possible to reduce the processing burden on the wireless terminal to determine whether or not the wireless terminal is outside of the communication area.

The wireless terminal may further include: a transmission unit that transmits second information that represents a position of the wireless terminal to a communication system that controls communication in the second telecommunication network; and a receiver that receives first information that represents a relationship between the wireless terminal and the communication area from the communication system. In such a case, the determination unit may determine based on the first information, whether or not the wireless terminal is outside of the communication area.

Thus, it is possible to obtain information representing whether or not the connection with the first telecommunication network is possible by radio, from the communication system of the second telecommunication network to which the communication is switched.

Moreover, the wireless terminal may further include a transmission unit that transmits second information that represents a position of the wireless terminal to a communication system that control communication in a third telecommunication network connected by radio. In such a case, the receiver may receive the first information from the communication system.

Thus, it is possible to obtain information representing whether or not the connection with the first telecommunication network is possible, from the communication system of the third telecommunication network to which the wireless terminal is being connected regardless of the switching of the communication. For example, when switching data communication from the second telecommunication network to the first telecommunication network, information representing whether or not the connection with the first telecommunication network is possible, is obtained from the communication network of the third telecommunication network for the voice communication.

Moreover, the aforementioned transmission unit may transmit the second information by a short message or internet mail. Moreover, the aforementioned receiver may receive the first information by a short message or internet mail.

Thus, by using a typical transmission method, the second information and the first information can be transmitted or received surely.

Moreover, the wireless terminal may further include a second determination unit that repeats to determine a transmission timing according to passage of time. In such a case, the transmission unit may transmit the second information to the communication system at the determined transmission timing.

When repetitively transmitting the second information representing the position of the wireless terminal, the first information representing whether or not the wireless terminal is outside of the communication area is repetitively received, and it is possible to increase the chance of omitting the search for the base station or access point.

Moreover, the wireless terminal may include a third determination unit that determines a timing according to a state of wireless communication with the second telecommunication network. In such a case, the transmission unit may transmit the second information to the communication system at the determined timing.

Thus, it is possible to omit the search for the base station or access point appropriately according to the communication state with the second telecommunication network. When trying to switch to the communication with the first telecommunication network according to the communication state with the second telecommunication network, it is useful for omitting the search whose effectiveness is low.

A communication control method relating to a second aspect of the embodiments include: (A) transmitting first information that represents a position of a wireless terminal from the wireless terminal to a communication system that controls a first telecommunication network that is connectable with the wireless terminal by radio; (B) receiving, by the communication system, the first information; (C) identifying, by the communication system, second information that represents a relationship between the wireless terminal and a communication area that is connectable to a second telecommunication network by radio, based on the position of the wireless terminal, which is represented by the received first information; (D) transmitting, by the communication system, the second information to the wireless terminal; (E) receiving, by the wireless terminal, the second information; and (F) determining, by the wireless terminal, whether or not the wireless terminal is outside of the communication area, based on the received second information. In such a case, search, by the wireless terminal, for a base station or an access point that relays the second telecommunication network is omitted upon determining that the wireless terminal is outside of the communication area.

By employing such a configuration, in case of switching the telecommunication network during the communication, it is possible to obtain information representing whether or not the connection with the second telecommunication network by radio is possible, from the communication system of the first telecommunication network that is being connected by radio. Furthermore, it is possible to suppress the power required for the search for the base station or access point for the second telecommunication network.

Moreover, the communication system may include a database that stores relationships between predetermined positions and communication areas. In such a case, the aforementioned communication control method may further include: (G) determining, by the wireless terminal, whether or not the wireless terminal is inside of the communication area, based on the received second information; (H) upon determining that the wireless terminal is inside of the communication area, searching, by the wireless terminal, for the base station or the access point; (I) transmitting, by the wireless terminal, third information that represents a result of the searching to the communication system; receiving, by the communication system, the third information; and (J) updating, by the communication system, the database based on the received third information.

By doing so, the communication system of the first telecommunication network can collect information concerning the communication areas of the second telecommunication network.

A communication system relating to the third aspect of the embodiments is a system for controlling communication of a first telecommunication network that is connectable with a wireless terminal by radio. The communication system includes: (a) a receiver that receives first information that represents a position of the wireless terminal and is transmitted by the wireless terminal;

(b) an identifying unit that identifies second information that represents a relationship between the wireless terminal and a communication area that is connectable with a second telecommunication network by radio, based on the position of the wireless terminal, which is represented by the received first information; and (c) a sender that sends the identified second information to the wireless terminal.

Thus, it is possible to send information that is effective to determine whether or not the connection with the second telecommunication network by radio is possible, to the wireless terminal that is being connected to the first telecommunication network by radio, and it is also possible to suppress the power consumption in the wireless terminal that tries to switch the telecommunication network during the communication.

Furthermore, the aforementioned receiver may receive third information that represents a result of search for a base station or access point that relays communication with the second telecommunication network and is transmitted from the wireless terminal, and the communication system may further include: an update unit that updates a database that stores relationships between predetermined positions and communication areas based on the received third information.

By doing so, the communication system of the first telecommunication network can collect the information concerning the communication area of the second telecommunication network.

Incidentally, it is possible to create a program causing a processor to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A wireless terminal comprising:
a memory; and
a processor configured to use the memory and execute a process, the processing comprising:
determining whether or not the wireless terminal is outside of a communication area that is connectable with a first telecommunication network by radio; and
upon determining that the wireless terminal is outside of the communication area, omitting search for abase station or access point that relays communication with the first telecommunication network.

2. The wireless terminal as set forth in claim 1, wherein the process further comprises:
upon determining that the wireless terminal is inside of the communication area, searching for the base station or the access point.

3. The wireless terminal as set forth in claim 2, wherein the process further comprises:
upon detecting the base station or the access point, connecting to the base station or the access point; and
switching from communication with a second telecommunication network that is being connected by radio to communication with the first telecommunication network.

4. The wireless terminal as set forth in claim 1, wherein the process further comprises:
determining whether or not the wireless terminal is near a boundary with the outside of the communication area; and
upon determining that the wireless terminal is near the boundary with the outside of the communication area, omitting the search for the base station or the access point.

5. The wireless terminal as set forth in claim 1, wherein the process further comprises:
determining whether or not the wireless terminal is near a boundary with the outside of the communication area, and whether or not a condition set for the wireless terminal is satisfied; and
upon determining that the wireless terminal is near the boundary with the outside of the communication area and the condition set for the wireless terminal is satisfied, omitting the search for the base station or the access point.

6. The wireless terminal as set forth in claim 3, wherein the process further comprises:
determining whether or not the wireless terminal is near a boundary with the outside of the communication area, and whether or not a condition for a state of wireless communication with the second telecommunication network; and
upon determining that the wireless terminal is near the boundary with the outside of the communication area and the condition is satisfied, omitting the search for the base station or the access point.

7. The wireless terminal as set forth in claim 5, wherein the condition is a condition to select a telecommunication network to be connected.

8. The wireless terminal as set forth in claim 1, wherein the process further comprises:
receiving first information that represents a relationship between the wireless terminal and the communication area, and
the determining is based on the first information.

9. The wireless terminal as set forth in claim 1, wherein the process further comprises:
transmitting second information that represents a position of the wireless terminal to a communication system that controls communication in the second telecommunication network; and
receiving first information that represents a relationship between the wireless terminal and the communication area from the communication system, and
the determining is based on the first information.

10. The wireless terminal as set forth in claim 8, wherein the process further comprises:
transmitting second information that represents a position of the wireless terminal to a communication system that control communication in a third telecommunication network connected by radio; and
receiving the first information from the communication system.

11. The wireless terminal as set forth in claim 9, wherein the second information is sent by a first short message or internet mail, and the first information is received by a second short message or internet mail.

12. The wireless terminal as set forth in claim 9, wherein the process further comprises:
repetitively determining a transmission timing according to passage of time, and
the second information is transmitted at the determined transmission timing.

13. The wireless terminal as set forth in claim 9, wherein the process further comprises:
determining a timing according to a state of wireless communication with the second telecommunication network, and
the second information is transmitted at the determined timing.

14. A communication control method, comprising:
transmitting first information that represents a position of a wireless terminal from the wireless terminal to a communication system that controls a first telecommunication network that is connectable with the wireless terminal by radio;
receiving, by the communication system, the first information;
identifying, by the communication system, second information that represents a relationship between the wireless terminal and a communication area that is connectable to a second telecommunication network by radio, based on the position of the wireless terminal, which is represented by the received first information;
transmitting, by the communication system, the second information to the wireless terminal;
receiving, by the wireless terminal, the second information; and
determining, by the wireless terminal, whether or not the wireless terminal is outside of the communication area, based on the received second information, and
wherein search, by the wireless terminal, for a base station or an access point that relays the second telecommunication network is omitted upon determining that the wireless terminal is outside of the communication area.

15. The communication control method as set forth in claim 14, wherein the communication system comprises a database that stores relationships between predetermined positions and communication areas, and
the communication control method further comprises:
determining, by the wireless terminal, whether or not the wireless terminal is inside of the communication area, based on the received second information;
upon determining that the wireless terminal is inside of the communication area, searching, by the wireless terminal, for the base station or the access point;
transmitting, by the wireless terminal, third information that represents a result of the searching to the communication system;
receiving, by the communication system, the third information; and
updating, by the communication system, the database based on the received third information.

16. A communication system for controlling communication of a first telecommunication network that is connectable with a wireless terminal by radio, the communication system comprising:
a memory; and
one or plural processors configured to use the memory and execute a process, the process comprising:
receiving first information that represents a position of the wireless terminal and is transmitted by the wireless terminal;
identifying second information that represents a relationship between the wireless terminal and a communication area that is connectable with a second telecommunication network by radio, based on the position of the wireless terminal, which is represented by the received first information; and
sending the identified second information to the wireless terminal.

17. The communication system as set forth in claim 16, wherein the process further comprises:
receiving third information that represents a result of search for a base station or access point that relays communication with the second telecommunication network and is transmitted from the wireless terminal; and
updating a database that stores relationships between predetermined positions and communication areas based on the received third information.
